(19) United States
(12) Patent Application Publication
(10) Pub. No.: US 2025/0008378 A1
(43) Pub. Date: Jan. 2, 2025

(54) IMPLEMENTING A DYNAMICAL ANTENNA ARRAY RECONFIGURATION IN A TELECOMMUNICATIONS NETWORK

(71) Applicants: RAKUTEN MOBILE, INC., Tokyo (JP); Rakuten Symphony India Private Limited, Indore, MP (IN)

(72) Inventors: Lingasamy VELUCHAMY, Karnataka (JP); Awn MUHAMMAD, Tokyo (JP)

(73) Assignees: RAKUTEN MOBILE, INC., Tokyo (JP); Rakuten Symphony India Private Limited, Indore, MP (IN)

(21) Appl. No.: 18/692,143

(22) PCT Filed: Dec. 27, 2023
(86) PCT No.: PCT/US2023/086006

§ 371 Date: Mar. 14, 2024

(30) Foreign Application Priority Data
Dec. 28, 2022 (IN) 202221076397
Feb. 3, 2023 (IN) 202321007046
Mar. 10, 2023 (IN) 202321016149
Mar. 31, 2023 (IN) 202341024486
May 4, 2023 (IN) 202341031813

(51) Int. Cl. H04W 28/18; H04L 41/0816; H04L 41/0853; H04W 28/02; H04W 52/02

(52) U.S. Cl. CPC H04W 28/18; H04L 41/0816; H04L 41/0853; H04W 28/0215; H04W 52/0206

(57) ABSTRACT

Method for implementing a dynamical antenna array reconfiguration through a C-Plane within an O-RAN, the method includes: receiving, by a distributed unit (O-DU) from a radio unit (O-RU), configuration capability information via management plane (M-Plane) messaging from the O-RU; receiving, by the O-DU from a higher-layer network function, a request to reconfigure an antenna array; based on the configuration capability information from the O-RU and based on the request to reconfigure the antenna array from the higher-layer network function, determining, by the O-DU, an antenna array configuration supported by the O-RU; and applying, by the O-DU, the supported antenna array configuration via C-Plane messaging or M-Plane messaging to the O-RU.

### CROSS-REFERENCE TO RELATED APPLICATIONS

This application is based on and claims priorities from Indian Provisional Patent Application No. 202221076397 filed on Dec. 28, 2022, Indian Provisional Patent Application No. 202341031813 filed on May 4, 2023, Indian Provisional Patent Application No. 202321007046 filed on Feb. 3, 2023, Indian Provisional Patent Application No. 202321016149 filed on Apr. 10, 2023, and Indian Provisional Patent Application No. 202341024486 filed on Apr. 31, 2023, the disclosures of which are incorporated by reference herein in their entireties.

### TECHNICAL FIELD

The present disclosure relates to the implementation of a dynamical antenna array reconfiguration within an open radio access network (O-RAN), to save energy in a telecommunications network.

### BACKGROUND

A radio access network (RAN) is an important component in a telecommunications system, as it connects end-user devices (or user equipment) to other parts of the network. The RAN includes a combination of various network elements (NEs) that connect the end-user devices to a core network. Traditionally, the hardware and/or software of a particular RAN is vendor specific.

Open RAN (O-RAN) technology has emerged to enable multiple vendors to provide hardware and/or software to a telecommunications system. To this end, O-RAN disaggregates the RAN functions into a centralized unit (CU), a distributed unit (DU), and a radio unit (RU). The CU is a logical node for hosting Radio Resource Control (RRC), Service Data Adaptation Protocol (SDAP), and/or Packet Data Convergence Protocol (PDCP) sublayers of the RAN. The DU is a logical node hosting Radio Link Control (RLC), Media Access Control (MAC), and Physical (PHY) sublayers of the RAN. An O-RU, i.e., the RU of an O-RAN, is a physical node that converts radio signals from antennas to digital signals that can be transmitted over the FrontHaul to an O-DU, i.e., a DU of an O-RAN. Because these entities have open protocols and interfaces between them, they can be developed by different vendors.

FIG. 1 illustrates a related art O-RAN architecture. Referring to FIG. 1, RAN functions in the O-RAN architecture are controlled and optimized by a Radio Access Network Intelligent Controller (RIC). The RIC is a software-defined component that implements modular applications to facilitate the multivendor operability required in the O-RAN system, as well as to automate and optimize RAN operations. The RIC is divided into two types: a non-real-time RIC (NRT-RIC) and a near-real-time RIC (nRT-RIC).

The NRT-RIC is the control point of a non-real-time control loop and operates on a timescale greater than 1 second within the Service Management and Orchestration (SMO) framework. Its functionalities are implemented through modular applications called rApps (rApp 1, . . . , rApp N), and include: providing policy-based guidance and enrichment across the A1 interface, which is the interface that enables the communication between the NRT-RIC and the nRT-RIC; performing data analytics; Artificial Intelligence/Machine Learning (AI/ML) training and inference for RAN optimization; and/or recommending configuration management actions over the O1 interface, which is the interface that connects the SMO to RAN managed elements (e.g., nRT-RIC, O-RAN Centralized Unit (O-CU), O-RAN Distributed Unit (O-DU), etc.).

The nRT-RIC operates on a timescale between 10 milliseconds and 1 second and connects to the O-DU, O-CU (disaggregated into the O-CU control plane (O-CU-CP) and the O-CU user plane (O-CU-UP)), and an open evolved NodeB (O-eNB) via the E2 interface. The nRT-RIC uses the E2 interface to control the underlying RAN elements (E2 nodes/network functions (NFs)) over a near-real-time control loop. The nRT-RIC monitors, suspends/stops, overrides, and controls the E2 nodes (O-CU, O-DU, and O-eNB) via policies. For example, the nRT-RIC sets policy parameters on activated functions of the E2 nodes. Further, the nRT-RIC hosts xApps to implement functions such as quality of service (QoS) optimization, mobility optimization, slicing optimization, interference mitigation, load balancing, security, etc. The two types of RICs work together to optimize the O-RAN. For example, the NRT-RIC provides, over the A1 interface, the policies, data, and artificial intelligence/machine learning AI/ML models enforced and used by the nRT-RIC for RAN optimization, and the nRT-RIC returns policy feedback (i.e., how the policy set by the NRT-RIC works).

The SMO framework, within which the NRT-RIC is located, manages and orchestrates RAN elements. Specifically, the SMO manages and orchestrates what is referred to as the O-RAN Cloud (O-Cloud). The O-Cloud is a collection of physical RAN nodes that host the RICs, O-CUs, and O-DUs, the supporting software components (e.g., the operating systems and runtime environments), and the SMO itself.

In the related art, the O-RU reports a rectangular coordinate system-based standardized antenna array model to the O-DU. The rectangular coordinate system-based standardized antenna array model is hardcoded by the O-RU vendor as a read-only. Moreover, the O-DU may not be aware of the internal architecture of O-RU, i.e., physical antenna element connection with Radio Frequency (RF) transceiver ports.

As a result, in the related art, muting (e.g., turning off) the part of antenna elements along with their respective RF transceiver chains is not possible. The lack of communication between the O-DU and O-RU according to the related art as set forth above has the disadvantage that in case of specific O-RAN conditions predetermined by an operator (e.g., O-RAN loads, when the expected traffic volume or the number of connected users is lower than a configured threshold), the high-power consumption of O-RUs due vendor-centric, proprietary setting of TRx arrays causes an energy ineffective operation of the RUs within the O-RAN.

### SUMMARY

Example embodiments of the present disclosure relate to implementing a dynamical antenna array reconfiguration within an open radio access network (O-RAN) to save energy in a telecommunications network. Further, example embodiments provide a notification mechanism between the O-RU and the O-DU without significant changes of existing O-RAN management plane (M-Plane) and control user synchronization plane (CUS-Plane) specifications to execute and indicate a transition from one antenna array configuration to another antenna array configuration while allowing the O-RU to report its O-RU's configuration capability information (e.g., the O-RU internal architecture) to the O-DU and the O-DU to apply an antenna array configuration (e.g., either generated or predefined beam weights to the antenna models) in a manner supported by the configuration capability information of the O-RU. As a result, the antenna calibration requirements against each antenna array configuration are met and maximum energy-saving can be achieved by muting physical and functional components of the O-RU according to the O-RU's configuration capability information (e.g., the O-RU's internal architecture).

According to an embodiment, an apparatus includes a distributed unit (O-DU) configured to receive configuration capability information from a radio unit (O-RU) via management plane (M-Plane) messaging. The O-DU receives a request to reconfigure an antenna array from a higher-layer network function. The O-DU, based on the configuration capability information from the O-RU and based on the request to reconfigure the antenna array from the higher-layer network function, determines an antenna array configuration supported by the O-RU. The O-DU applies the supported antenna array configuration via C-Plane messaging or M-Plane messaging to the O-RU.

According to an embodiment, an apparatus includes a radio unit (O-RU) configured to send, to a distributed unit (O-DU), configuration capability information of the O-RU via management plane (M-Plane) messaging. The O-RU receives, from the O-DU, an antenna array configuration supported by the O-RU via control plane (C-Plane) messaging or management plane (M-Plane) messaging, wherein the supported antenna array configuration is based on the configuration capability information of the O-RU and a request to reconfigure the antenna array from a higher-layer network function. The O-RU, based on the supported antenna array configuration for the O-RU, changes the antenna array configuration of the O-RU.

According to an embodiment, a method includes receiving, by a distributed unit (O-DU) from a radio unit (O-RU), configuration capability information via management plane (M-Plane) messaging from the O-RU. The method includes receiving, by the O-DU from a higher-layer network function, a request to reconfigure an antenna array. The method includes determining, by the O-DU, an antenna array configuration supported by the O-RU based on the configuration capability information from the O-RU and based on the request to reconfigure the antenna array from the higher-layer network function. The method includes applying, by the O-DU, the supported antenna array configuration via C-Plane messaging or M-Plane messaging to the O-RU;

According to an embodiment, a method includes sending, by a radio unit (O-RU) to a distributed unit (O-DU), configuration capability information via management plane (M-Plane) messaging. The method includes receiving, by the O-RU from the O-DU, an antenna array configuration supported by the O-RU via control plane (C-Plane) messaging or management plane (M-Plane) messaging, wherein the supported antenna array configuration is based on the configuration capability information of the O-RU and a request to reconfigure the antenna array from a higher-layer network function. The method includes based on the supported antenna array configuration for the O-RU, changing, by the O-RU, the antenna array configuration of the O-RU.

According to an embodiment, a non-transitory computer-readable recording medium having recorded thereon instructions executable by at least one processor to perform a method. The method includes receiving, by a distributed unit (O-DU) from a radio unit (O-RU), configuration capability information via management plane (M-Plane) messaging from the O-RU. The method includes receiving, by the O-DU from a higher-layer network function, a request to reconfigure an antenna array. The method includes determining, by the O-DU, an antenna array configuration supported by the O-RU based on the configuration capability information from the O-RU and based on the request to reconfigure the antenna array from the higher-layer network function. The method includes applying, by the O-DU, the supported antenna array configuration via C-Plane messaging or M-Plane messaging to the O-RU.

According to an embodiment, a non-transitory computer-readable recording medium has recorded thereon instructions executable by at least one processor to perform a method. The method includes sending, by a radio unit (O-RU) to a distributed unit (O-DU), configuration capability information via management plane (M-Plane) messaging. The method includes receiving, by the O-RU from the O-DU, an antenna array configuration supported by the O-RU via control plane (C-Plane) messaging or management plane (M-Plane) messaging, wherein the supported antenna array configuration is based on the configuration capability information of the O-RU and a request to reconfigure the antenna array from a higher-layer network function. The method includes based on the supported antenna array configuration for the O-RU, changing, by the O-RU, the antenna array configuration of the O-RU.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates an O-RAN architecture in the related art;

FIG. 2 illustrates the method for implementing a dynamical antenna array reconfiguration from the perspective of an O-DU according to an embodiment;

FIG. 3 illustrates the method for implementing a dynamical antenna array reconfiguration from the perspective of an O-RU according to an embodiment;

FIG. 4 illustrates a method of M-Plane messaging comprising a Yang model for capability reporting of sleep modes and associated parameters according to an embodiment;

FIG. 5 illustrates a flowchart for M-Plane/C-Plane messaging between an O-RU and an O-DU for the use case of sleep modes;

FIG. 6 illustrates a method of M-Plane messaging comprising a Yang model for capability reporting of TRx control parameters along with a Yang model for capability reporting of data layer control parameters according to an embodiment;

FIG. 7 illustrates a flowchart for M-Plane/C-Plane messaging between an O-RU and an O-DU for the use case of TRx control;

FIG. 8 illustrates a method implementing a TRx control process via at least one Section Type 4 message in the C-Plane according to an embodiment;

FIG. 9 illustrates a method implementing a TRx control process via Section Type 0 message in the C-Plane according to an embodiment;

FIG. 10 illustrates a parameter for selecting antenna array reconfiguration using an ST4 message according to an embodiment;

FIG. 11 illustrates command common header fields for applying an antenna array reconfiguration using an ST4 message according to an embodiment;

FIG. 12A illustrates an embodiment of sleep modes according to a Section Type 4 command type (ST4CmdType) TRx control;

FIG. 12B illustrates another embodiment of the sleep modes according to a Section Type 4 command type (ST4CmdType) TRx control;

FIG. 13 illustrates parameters and command common header fields for applying an antenna array reconfiguration using Section Type (ST) 0 messages according to an embodiment;

FIG. 14A illustrates a method for notifying a configuration change via a ST4CmdType of ST4 message in the C-Plane according to an embodiment;

FIG. 14B illustrates a method for notifying a configuration change via a reserved field in an ST8 message in the C-Plane according to an embodiment;

FIG. 15A illustrates a command common header field for a TRx control configuration success notification using ACK/NACK in an ST4 message according to an embodiment;

FIG. 15B illustrates a command common header field for a TRx control configuration success notification using a reserved field in an ST8 message;

FIG. 16 is a diagram of an example environment in which systems and/or methods, described herein, may be implemented; and

FIG. 17 is a diagram of example components of a device according to an embodiment.

### DETAILED DESCRIPTION

The following detailed description of example embodiments refers to the accompanying drawings. The foregoing disclosure provides illustration and description but is not intended to be exhaustive or to limit the implementations to the precise form disclosed. Modifications and variations are possible in light of the above disclosure or may be acquired from the practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that apparatuses and/or methods, described herein, may be implemented in different forms of hardware, firmware, or a combination of hardware and software. The actual specialized control hardware or software code used to implement these apparatuses, systems and/or methods is not limited to the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide systems and methods in which an NRT-RIC framework and/or a rApp configure RF channel reconfiguration parameters (e.g., for switching off/on Tx/Rx arrays in m-MIMO antennas in O-RUs) that allow for a flexible RF channel reconfiguration by, for example, A1 policies or optimization triggers over O1 interface formulated by NRT-RIC (i.e., by the at least one rApp hosted by the NRT-RIC and/or the NRT-RIC framework assisted by machine learning (ML) techniques) towards the nRT-RIC, wherein the nRT-RIC via E2 interface actions may enforce the deployment of the O1 configuration data to prepare and execute the RF channel reconfiguration towards one or more E2 nodes, wherein the implementation based on said O1 configuration data to prepare and execute an RF channel reconfiguration in the O-RU is commenced by the E2 nodes via the open FH M-Plane interface between the E2 node and the O-RU.

To this end, before applying an RF channel reconfiguration (e.g., switching off/on Tx/Rx arrays), the E2 node may need to perform preparation actions for RF channel reconfiguration. For example, the E2 node may check load statistics per cell and per carrier, such as number of active users, average number of Radio Resource Control (RRC) connections, average number of scheduled active users per Transmission Time Interval (TTI), Physical Resource Block (PRB) utilization, DownLink/UpLink (DL/UL) Cell/User throughput, Precoding Matrix Indicator/Channel State Information (PMI/CSI) reports. Moreover, the E2 node may check the latency statistics per cell (e.g., if the Ultra-Reliable Low Latency Communications (URLLC) slices are involved, latency is used for energy efficiency EE definition).

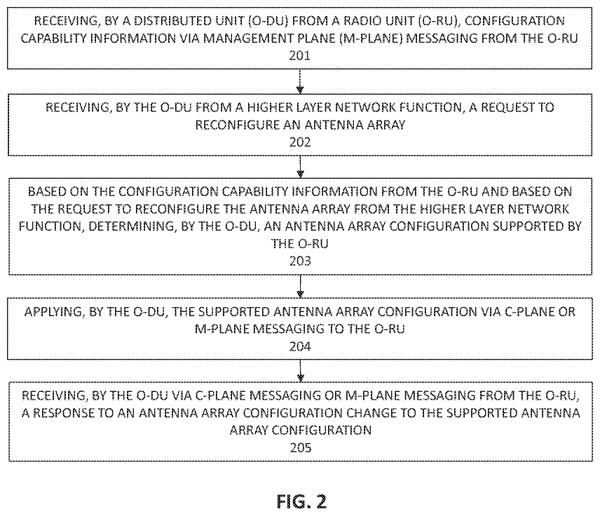

FIG. 2 illustrates the method for implementing a dynamical antenna array reconfiguration from the perspective of an O-DU according to an embodiment. Referring to FIG. 2, in step 201, the O-DU receives configuration capability information from a radio unit (O-RU) of the O-RAN via management plane (M-Plane) messaging. For example, the O-RU reports configuration capability information such for example supported energy-saving modes by O-RU-urn:o-ran:module-cap:1.0.

For example, the antenna configuration capability information may be hardcoded by the vendor during production along with at least one of the following parameters, a unique name, index, reference, etc. to identify the antenna array configuration capability (e.g., the technical specification of the antenna array), the number of spatial streams/layers supported against each configuration of the antenna array, the antenna calibration data to be applied by O-RU during the configuration change, a value referring to the achievable energy-savings against each configuration, associated beam weights (pre-defined beam weights), etc. In an example embodiment, when O-RU is powered on (is initialized), the O-RU starts reporting supported energy-saving modes (i.e., antenna array configuration capability information) and the hardcoded antenna array models along with the other initialization parameters to the O-DU using M-Plane yang models (e.g., an urn:o-ran:module-cap:1.0 and an urn:o-ran:hardware:1.0).

In an example embodiment, energy-saving-by-transmission-blanks parameter may be used for sending configuration capability information from the O-RU to the O-DU. This allows the use of existing M-Plane models, to provide (i.e., define) new parameters to enable the O-RU to report new energy-saving parameters (e.g., energy-saving-by-rf-channel-reconfiguration, energy-saving-by-advanced-sleep-modes, energy-saving-by-modify-no-of-spatial-streams, etc.).

An example for energy-saving-by-transmission-blanks parameter in an M-Plane model may be as follows:

```
leaf energy-saving-by-transmission-blanks {
type boolean;
mandatory true;
description
“Parameter informs if unit supports energy-saving by transmission blanking”;
}
grouping Energy-saving-method {
status active;
description
“Grouping for energy-saving method.
Note: This grouping is meant for energy-saving methods.”;
leaf energy-saving-method {
type enumeration {
enum RF CHANNEL RECONFIGURATION {
description
“RF Channel Reconfiguration will be used”;
}
enum ADVANCED SLEEP MODE {
description
“Advanced Sleep Mode will be used”;
}
enum MODIFY NO OF SPATIAL STREAMS {
description
“No of Spatial Streams will be modified”;
}
}
description
“Energy-saving method which can be supported by the O-RU.
An O-RU may further refine the applicability of energy-saving
methods per endpoint using o-ran-uplane-conf.yang model”;
}
}
leaf energy-saving-by-RF-channel-reconfiguration {
type boolean;
mandatory true;
description
“Parameter informs if unit supports energy-saving by RF channel reconfiguration”;
}
  leaf energy-saving-by-Advanced-Sleep-Mode {
type boolean;
mandatory true;
description
“Parameter informs if unit supports energy-saving by Advanced sleep mode”;
}
  leaf energy-saving-by-modify-no-of-spatial-streams {
type boolean;
mandatory true;
description
“Parameter informs if unit supports energy-saving by Modifying no of spatial streams/layers”;
}
container eaxcid-grouping-capabilities {
if-feature o-ran-module-cap:EAXC-ID-GROUP-SUPPORTED;
description
“a container with parameters for eaxcid grouping”;
leaf max-num-tx-eaxc-id-groups {
type uint8;
description
“Maximum number of configurable tx-eaxc-id-group supported by O-RU.”;
}
leaf max-num-tx-eaxc-ids-per-group {
type uint8;
description
“Maximum number of eAxC IDs per tx-eaxc-id-group supported by O-RU, where each group is
a union of the ‘member-tx-eaxc-id's and a ‘representative-tx-eaxc-id’.”;
}
leaf max-num-rx-eaxc-id-groups {
type uint8;
description
“the maximum number of groups with the eAxC IDs those are assigned to low-level-rx-links.”;
}
leaf max-num-rx-eaxc-ids-per-group {
type uint8;
description
```

Regarding existing M-Plane yang models, to ensure backward compatibility, the O-RU may flag the above-mentioned energy-saving mode to false, if the O-RU does not support custom configurations or RF channel reconfigurations/antenna array selection approach for ES.

In another example embodiment, O-RU configuration capability information may comprise supported features such as, for example, supported energy-saving features in o-ran-wg4-features.yang. The O-RU may indicate the supported energy-saving features in the o-ran-wg4-features.yang to O-RU controller (i.e., the O-DU or the higher-layer network functions (e.g., the SMO)).

According to an embodiment, in line with the O-RAN Open Fronthaul M-Plane Specification, which defines the Management Plane of the Open Fronthaul Interface as well as associated YANG models, the O-RU may indicate the supported energy-saving features in associated YANG models a Yang Features such as, for example, o-ran-wg4-features.yang, to an O-RU controller such as the O-DU and/or higher order network function (i.e., the SMO, etc.).

To this end, the O-RU configuration capability information may comprise O-RU-supported feature capabilities using YANG Feature Name Tags such as, for example, TRX-CONTROL, TRX-ON-OFF, ADVANCED-SLEEP-MODE, SLEEP-MODE, LIGHT-HIBERNATE-SLEEP, DEEP-HIBERNATE-SLEEP (i.e., DEEP SLEEP), etc.

The YANG Feature Name Tags TRX-CONTROL or TRX-ON-OFF may describe the turning on/off RF channels or Tx/Rx array elements (i.e., of RF channels or Tx/Rx array elements switch on or off), whereas an M-Plane activation as optional feature control may be not available.

The YANG Feature Name Tags ADVANCED-SLEEP-MODE or SLEEP-MODE may describe turning off carriers and associated O-RU circuit(s) and/or O-RU component(s) (i.e., muting and/switching on/off physical and functional components of the O-RU) based on the respective activated sleep mode, whereas an M-Plane activation as optional feature control may be not available.

The YANG Feature Name Tag HIBERNATE-SLEEP may describe an O-RU Energy-saving by turning off carriers and associated O-RU circuits/components for a longer duration, wherein the longer duration in comparison to other sleep modes allows an optional feature control to be implemented hardware/component/energy-saving-enabled as an M-Plane based sleep mode.

The YANG Feature Name Tag LIGHT-HIBERNATE-SLEEP may describe O-RU Energy-saving by turning off carriers and associated O-RU circuits/components for a longer duration without turning off synchronization, wherein the longer duration in comparison to other sleep modes allows an optional feature control to be implemented hardware/component/energy-saving-enabled as an M-Plane based sleep mode.

The YANG Feature Name Tag DEEP-HIBERNATE-SLEEP (i.e., DEEP SLEEP) may describe O-RU Energy-saving by turning off carriers and associated O-RU circuits/components for a longer duration by turning off synchronization, wherein the longer duration in comparison to other sleep modes allows an optional feature control to be implemented hardware/component/energy-saving-enabled as an M-Plane based sleep mode.

According to an example embodiment, referring to the YANG Feature Name Tags ADVANCED-SLEEP-MODE or SLEEP-MODE may define various short duration (C Plane based) sleep modes, for example, the advanced sleep mode may be for shorter sleep duration like milliseconds, seconds, or minutes and activated, for example, with ST4 C Plane message by Control Plane (C-Plane) messaging.

According to an example embodiment, referring to the YANG Feature Name Tag HIBERNATE-SLEEP for longer duration a hibernate-sleep mode may be activated by employing M-Plane, for example, by setting the parameter +-rw energy-saving-enabled? boolean {ENERGYSAVING}? in the respective o-ran-hardware.yang module to “True” or “Yes”.

According to an example embodiment, referring to the YANG Feature Name Tags LIGHT-HIBERNATE-SLEEP and DEEP-HIBERNATE-SLEEP in order to differentiate the longer sleep with and without turning off synchronization plane circuit, light-hibernate-sleep mode with synchronization and deep-hibernate-sleep mode without synchronization may be implemented in a same way as that of hibernate-sleep by employing the M-Plane, for example, by setting the parameter +-rw energy-saving-enabled? boolean {ENERGYSAVING}? in the respective o-ran-hardware.yang module to “True” or “Yes”.

Referring to the O-RU reporting to the O-DU (i.e., the receiving of O-RU configuration capability information by the O-DU) based on yang modules such as, for example, as specified in the o-ran module.cap.yang, Advanced Sleep Modes (ASM) may support sleep modes (SM) having a short duration (C-Plane based) sleep modes (e.g., a plurality of Sleep modes such as, for example, SM #0, SM #1, SM #2, SM #3, etc. wherein the time duration of SM #0<SM #1<SM #2<SM #3) with different wake-up times or if the wake-up times is too short a defined go-to-sleep time. Moreover, the Advanced Sleep Modes (ASM) may support sleep modes having a long duration (M-Plane based) sleep modes (e.g., the hibernate sleep that does not involve any synchronization or the hibernate sleep modes with or without synchronization, whereas the light hibernate sleep refers to an M-Plane based sleep mode with synchronization and the deep hibernate sleep refers to an M-Plane based sleep mode without synchronization.

According to an embodiment, the Advanced Sleep Modes (ASM) have a wake-up time (minimum or guaranteed) per sleep mode. The shortest of the C-Plane-based sleep modes (e.g., SM #0) may be not defined by a minimum or guaranteed wake-up time but by go-to-sleep time.

The O-RU reporting to the O-DU and/or SMO based on yang modules such as, for example, as specified in the o-ran module.cap.yang, may also support of C-Plane messages such as Section Type 8 (ST8) “ready” message and C-Plane messages including a command scope (e.g., CARRIER-COMMAND, ARRAY-COMMAND, O-RU-COMMAND) such as, for example, a Section Type 4 (ST4) message.

According to an example embodiment, the TRx control methods to reconfigure the antenna array may include TRx control configurations that are identified by a respective unique configuration identity or name. The antenna array model of said TRx control configurations includes at least one antenna mask (antMask), wherein the antenna mask bits combination may be limited only to the supported TRx control configurations, wherein the antenna mask bits identify a ‘0’ for antenna elements to be turned off and ‘1’ for active elements of the antenna array. Moreover, TRx control configurations include in addition to the mask bits for at least one antenna mask (antMask), antenna layer mask bits for creating at least one antenna layer mask (antLayerMask).

To this end, the O-RU may report its capabilities via a Yang model o-ran-module-cap.yang for TRx control and data layer control. The Yang model o-ran-module-cap.yang may include the parameter following the summary.

o-ran-module-cap.yang - TRx control and data layer control
module: o-ran-module-cap
+−−rw module-capability

+−−ro ru-capabilities

//TRx control - Capability reporting
| +−−ro trx-control-capability {or-feat:TRX-CONTROL}?

| | |
|---|---|
| \| \| | +−−ro number-of-supported-trx-control-configuration? Uint8 //number of |

supported TRx control configuration.

| | |
|---|---|
| \| \| | +−−ro supported-trx-control-configuration* [name] |

| | | |
|---|---|---|
| \| \| | \| | +−−ro configuration-name |

string //unique name of each TRx control configuration

| | | |
|---|---|---|
| \| \| | \| | +−−ro antenna-mask? |

binary or bits //antMask list - antenna mask per TRx control config for all

| | | |
|---|---|---|
| \| \| | \| | +−−ro antenna-layer-mask? |

binary or bits //antLayerMask list - antenna layer mask per TRx control config for all

| | | | |
|---|---|---|---|
| \| \| | \| | +−−ro transition-time or wake-up-time | uint32 |

//transition time (list) associated with each configuration change for the supported TRx

control configurations and as a function of sub carrier spacing. Since for 15 KHz, 1 slot is 1
milli second, and for 30 KHz, 1 slot is 0.5 milli second or 500 micro-seconds

| | | |
|---|---|---|
| \| \| | \| | +−−ro energy-saving-ratio |

| | |
|---|---|
| uint8 | //percentage of energy-saving per TRx control configuration |

//data-layer/spatial streams control - Capability reporting
| +−−ro data-layer-control-supported? boolean {or-feat:TRX-CONTROL}? //Data layer
control/limiting no of spatial streams supported by O-RU or not?

According to an example embodiment, the supported TRx control configurations may comprise a transition time (i.e., different from a wake-up time of the ASMs) that defines a minimum or guaranteed time required to switch from baseline configuration to specific configuration (i.e., switch a baseline 64TRx antenna array to another antenna mask configuration such as, for example, a 32TRx_antenna array model). The transition time (i.e., wake-up time) associated with each configuration change for the supported TRx control configurations and as a function of sub-carrier spacing may be, for example, for 15 KHz, one slot is 1 millisecond, for 30 KHz, one slot is 0.5 millisecond or 500 microseconds, etc.

According to an example embodiment, the O-Ru may report data layer control capability or the capability of limiting of number of spatial streams by a Yang model o-ran-module-cap.yang as set forth above for at least one supported (i.e., given) antenna configuration.

In an example embodiment, the TRx of an antenna array (e.g., a 64T64R antenna array) may be kept active, whereas the gain (i.e., energy-saving gain) may be realized from the turning off O-RU processing equipment by changing the number of data layers/spatial streams. According to an example embodiment, the TRx control methods may include control to turn on/off entire RF Transceiver chains and/or Radio Frequency Front End (RFFE) of Radio Frequency (RF) processing unit pertaining to some of the RF channels/antenna elements.

Moreover, according to another example embodiment, the TRx control methods may include control to turn on/off Components, Circuits, IPs, Cores, Computing engines of the digital baseband and O-RAN Fronthaul processing units (i.e., physical components of the O-RU).

According to embodiments of the Advanced Sleep Modes (ASM) having short duration (C-Plane based) sleep modes and sleep modes having long duration (M-Plane based) sleep modes the wake-up latency (i.e., the wake-up time or the go-to-sleep time) for said ASM and the wake-up latency of the TRx control may be different and not interfere with (e.g., hinder) each other.

The O-RU reporting to the O-DU and/or SMO based on yang modules such as, for example, as specified in the o-ran module.cap.yang, may also support sleep duration extension and emergency wake-up by M-Plane and/or C Plane messaging.

Moreover, the O-RU reporting to the O-DU and/or SMO based on yang modules such as, for example, as specified in the o-ran module.cap.yang may also provide information such as the percentage of achievable energy-savings

Furthermore, the O-RU reporting to the O-DU and/or SMO based on yang modules such as, for example, as specified in the o-ran module.cap.yang, may also support a notification messaging for CU plane active or inactive state, such as, for example, support a notification that may be required to ensure the CU plane become active after sleep duration expires (i.e., a CU plane circuit may be turned off in the case of defined, undefined, and/or longer sleep duration). To this end, the O-RU reporting to the O-DU and/or SMO supports notifications from O-RU to O-DU about CU plane status in case it is turned off during any of the sleep mode activations.

In general, the o-ran-module-cap.yang relates to common O-RU capabilities (i.e., O-RU configuration capability information for sleep modes (e.g., advanced sleep modes), CU-Plane status reporting to implement the sleep modes (e.g., advanced sleep modes) and TRx control methods.

To this end, the o-ran-module-cap.yang among other YANG models may comprise all necessary information to implement an antenna array configuration supported by the O-RU (i.e., based on said O-RU configuration capability information).

According to an example embodiment, the o-ran-module-cap.yang among other YANG models for TRx control methods to reconfigure the antenna array may include TRx control configurations that are identified by a respective unique configuration identity or name. The antenna array model of said TRx control configurations includes at least one antenna mask (antMask), wherein the antenna mask bits combination may be limited only to the supported TRx control configurations, wherein the antenna mask bits identify a ‘0’ for antenna elements to be turned off and ‘1’ for active elements of the antenna array. Moreover, TRx control configurations include in addition to the mask bits for at least one antenna mask (antMask), antenna layer mask bits for creating at least one antenna layer mask (antLayerMask).

The Yang model o-ran-module-cap.yang may include the parameters according to the following summary.

o-ran-module-cap.yang - Advanced sleep mode
module: o-ran-module-cap
+−−rw module-capability

+−−ro ru-capabilities

| +−−ro max-num-component-carriers? uint8
| x−−ro max-num-bands? uint16
//Advanced sleep mode - Capability reporting
| +−−ro advanced-sleep-mode-capability? enumeration {or-feat:ADVANCED-SLEEP-MODE}??

| | | |
|---|---|---|
| \| \| | +−−ro supported-sleep-modes* [name] | //list |

of supported sleep modes like sleep mode 0, 1, 2, and 3 (SM#0-3)

| | | |
|---|---|---|
| \| \| | \| | +−−ro sleep-mode-name |

| | |
|---|---|
| string | //sleepMode0 (SM#1), sleepMode1 (SM#2), sleepMode2 (SM#2), and |

sleepMode3 (SM#3)

| | | |
|---|---|---|
| \| \| | \| | +−−ro wake-up-time |

| | |
|---|---|
| uint32 | //wake-up time list (minimum or guaranteed) associated with each sleep |

mode and represented in slots as a function of Sub carrier spacing. For e.g., SM#1 - L slots,
SM#2 - M slots, and SM# 3 - N slots. The wake-up time in slots are listed for all supported sub
carrier spacing by O-RU. Since for 15 KHz, 1 slot is 1 milli second, and for 30 KHz, 1 slot is 0.5
milli second or 500 micro-seconds.

| | | |
|---|---|---|
| \| \| | \| | +−−ro energy-saving-ratio |

| | |
|---|---|
| uint8 | //percentage of energy-saving per sleep mode |

| | |
|---|---|
| \| +−−ro hibernate-sleep-capability {or-feat:HIBERNATE-SLEEP}? | //option# 1: |

longer sleep duration

| | | |
|---|---|---|
| \| \| | +−−ro hibernate-wake-up-time or wake-up-time-hibernate uint32 | //wake-up time in |

milli seconds for hibernate sleep
| +−−ro light-hibernate-sleep-capability {or-feat:LIGHT-HIBERNATE-SLEEP}? // option# 2a:
longer sleep duration with synchronization

| | | |
|---|---|---|
| \| \| | +−−ro lh-wake-up-time or wake-up-time-lh | uint32 |

//wake-up time in milli seconds for light hibernate sleep
| +−−ro deep-hibernate-sleep-capability {or-feat:DEEP-HIBERNATE-SLEEP}? // option# 2b:
longer sleep duration without synchronization

| | | |
|---|---|---|
| \| \| | +−−ro dh-wake-up-time or wake-up-time-dh | uint32 |

//wake-up time in milli seconds for deep hibernate sleep

| | |
|---|---|
| \| \| | +−−ro supported-command-scope* enumeration //supported ST4 command scope such as |

“CARRIER-COMMAND, ARRAY-COMMAND, O-RU-COMMAND” to be reported by O-RU.
For e.g., one or two or all three

| | |
|---|---|
| \| \| | +−−ro st8-ready-msg-supported? boolean //O-RU already reports the support of Section |

Type (ST) 8 message in supported-section-types, hence in NES perspective support of “ready”
command in ST8 message to reported by O-RU as a capability

| | |
|---|---|
| \| \| | +−−ro sleep-duration-extension-supported? boolean //in defined sleep, if O-DU wants to |

extend the ongoing sleep it can issue sleep extension C Plane command (short sleep duration)
and M-Plane command (long sleep duration). The supported of this could be advertised by O-RU
as an optional.

| | |
|---|---|
| \| \| | +−−ro emergency-wake-up-by-cplane-command-supported? boolean //(in defined (not |

guaranteed) or undefined sleep duration, O-DU could any time interrupt the sleep by issuing
emergency wake-up C Plane command, provided CU plane remain active or CU plane circuit
ON. This support could be advertised by O-RU as an optional.

| | |
|---|---|
| \| \| | +−−ro emergency-wake-up-by-mplane-command-supported? boolean //(in defined (not |

guaranteed) or undefined sleep duration, O-DU could any time interrupt the sleep by issuing
emergency wake-up command via an M-Plane as CU plane is turned off. This support could be
advertised by O-RU as an optional.

Referring to the summary as set forth above, the Common O-RU capabilities may be for both TRx control and Advanced sleep mode.

According to an example embodiment, the supported TRx control configurations may comprise a transition time (i.e., different from a wake-up time of the ASMs) that defines a minimum or guaranteed time required to switch from baseline configuration to specific configuration (i.e., switch a baseline 64TRx antenna array to another antenna mask configuration such as, for example, a 32TRx_antenna array model). The transition time (i.e., wake-up time) associated with each configuration change for the supported TRx control configurations and as a function of sub-carrier spacing may be, for example, for 15 KHz, one slot is 1 millisecond, for 30 KHz, one slot is 0.5 millisecond or 500 microseconds, etc.

According to an example embodiment, the TRx control methods may include control to turn on/off entire RF Transceiver chains and/or Radio Frequency Front End (RFFE) of Radio Frequency (RF) processing unit pertaining to some of the RF channels/antenna elements.

Moreover, according to another example embodiment, the TRx control methods may include control to turn on/off Components, Circuits, IPs, Cores, Computing engines of the digital baseband and O-RAN Fronthaul processing units (i.e., physical components of the O-RU).

According to embodiments of the Advanced Sleep Modes (ASM) having short duration (C-Plane based) sleep modes and sleep modes having long duration (M-Plane based) sleep modes the wake-up latency (i.e., the wake-up time or the go-to-sleep time) for said ASM and the wake-up latency of the TRx control methods may be different and not interfere with (e.g., hinder) each other.

Moreover, regarding common capability parameters to be reported by O-RU configuration capability information to the O-DU via an M-Plane for both TRx control methods and sleep modes (e.g., advanced sleep modes) may include C-Plane ST8 “ready” messages and sleep duration extension (e.g., in case of defined sleep, if the O-DU needs to extend a sleep mode it send a sleep extension command just before the start of wake-up time). In case the CU-Plane remains active, the extension command may be C-Plane-based for short sleep durations. In case the CU-Plane is turned off the extension command may be M-Plane based for long sleep durations.

Furthermore, regarding the common capability parameters to be reported by O-RU to the O-DU via an M-Plane, the capability information for both TRx control methods and sleep modes (e.g., advanced sleep modes) may include an emergency wake-up of O-RU from sleep. This capability may be reported by O-RU via the M-Plane. For example, in case of sleep mode interruption, if the O-DU needs to interrupt a sleep mode it sends a sleep mode interruption command. In case the CU-Plane remains active, the emergency wake-up command may be C-Plane-based for short sleep durations (defined or undefined). In case the CU-Plane is turned off the emergency wake-up command may be M-Plane-based for long sleep durations (defined or undefined).

According to an example embodiment, the o-ran-module-cap.yang among other YANG models for CU-Plane status reporting (e.g., to implement O-RU capabilities for defined and undefined sleep modes). The o-ran-module-cap.yang comprises information to enable a CU Plane circuit to be turned off to attain additional energy-saving. The information may include a name identifier and a status identifier of the Rx-array-carriers as well as a name identifier, action identifier and state for the cu-plane in order to report the user plane configuration. Based on the above information, the O-DU may turn on or wake-up the CU-Plane circuit through the M-Plane (i.e., an M-Plane command). According to an example embodiment, a notification is needed to indicate if CU-Plane becomes active or not (wake-up from sleep), the same may be defined in the o-ran-uplane.yang, respectively.

The Yang model o-ran-uplane.yang may include the parameter according to the following summary.

o-ran-uplane-conf.yang
+−−ro rx-array-carriers* [name]
+−−ro name −> /user-plane-configuration/rx-array-carriers/name
+−−ro state? −> /user-plane-configuration/rx-array-carriers/state
+−−− n cu-plane-state-change
| +−−ro cu-plane [name]
| +−−ro active? −> /user-plane-configuration/cu-plane/active;
Active/Inactive
| +−−ro state? −> /user-plane-configuration/cu-plane/state:
Enabled/Disabled

According to an example embodiment for the use case RF Channel Reconfiguration (i.e., RF Channel Switch Off/On) a sub-use case may be defined as TRx Control (i.e., a Tx array control and Rx array control may be claimed separately since antenna masks may be defined per array level. For this sub-use case, the O-RU may include at least one of the following capability reporting (i.e., configuration capability information). The configuration capability information may include among other capability reporting at least the reporting of support of a C-Plane and an M-Plane based TRx control activation/deactivation, the reporting of a list of supported antenna array configuration/TRx control configurations (e.g., valid antenna mask values (per antenna array configuration values) along with unique name, the reporting of wake-up time/duration as a function of SCS (Sub-carrier spacing) (i.e., this wake-up may be different from the wake-up time/duration reported for Advanced sleep mode), the reporting of the support of TRx control sleep modes, the reporting of the amount of achievable energy-saving/power saving/energy-saving ratio per antenna array configuration (Tx array and/or Rx array) or TRx control (Tx control and/or Rx control), the reporting of the support of defined and undefined duration sleep, ST8 ready message, sleep duration extension, and emergency wake-up and the reporting of the O-RU internal architecture (functional blocks) using valid yang data model parameters to attain maximum energy-savings (i.e., exposing the O-RU internal architecture).

According to another example embodiment for the use case RF Channel Reconfiguration (i.e., RF Channel Switch Off/On) a sub-use case may be defined as Data layer Control. For this sub-use case, the capability reporting (i.e., configuration capability information) may include a list of the maximum of supported spatial streams/data layers per antenna array (TRx Control) configuration.

According to another example embodiment, a use case may be defined as Advanced Sleep Mode. For this sub-use case, the O-RU may include at least one of the following capability reporting (i.e., configuration capability information). The configuration capability information may include among other capability reporting at least the reporting of a wake-up duration associated with each sleep mode as a function of the SCS, the reporting of the amount of achievable energy-saving per sleep mode type, the reporting of the support of defined and undefined duration sleep, ST8 ready message, sleep duration extension, and emergency wake-up.

According to another example embodiment for the use case, RF Channel Reconfiguration (i.e., RF Channel Switch Off/On) a sub-use case may be defined as Hibernate sleep. For this sub-use case, the O-RU may include at least one of the following capability reporting (i.e., configuration capability information). The configuration capability information may include among other capability reporting at least the reporting of support of Hibernate sleep such as long duration sleep (light/deep sleep), the reporting of support of removal/de-configuring the carriers by the O-RU during long sleep, the reporting of support of turning off the C-Plane, U-Plane, S-Plane, and M-Plane processing units (i.e., the support of an O-DU request (e.g., by sending appropriate RPC(s)) or by the O-RU's internal logic)).

In step 202, the O-DU receives the request to reconfigure an antenna array from the higher-layer network function. The request to reconfigure an antenna array is based on a monitored network parameter satisfying a predetermined condition. In an example embodiment, the higher-layer network function may determine whether a current network parameter (e.g., a current network parameter reflected by the O1-related KPIs such as, for example, throughput, number of users in a cell, user statistics, etc.) is satisfying a predetermined condition (i.e., a predetermined threshold that relates to O-RAN network condition). The predetermined network parameter may be based on Rank Indicator (RI) value shared by a UE, traffic scenarios, etc. that can be derived by said O1 interface-related KPIs such for example, throughput, number of users in a cell, user statistics, etc.).

In step 203, the O-DU determines an antenna array configuration supported by the O-RU. The determined antenna array configuration is based on the configuration capability information from the O-RU as set forth in step 201 and based on the request to reconfigure an antenna array from the higher-layer network function as set forth in step 202.

In step 204, the O-DU applies the supported antenna array configuration via control plane (C-Plane) messaging or via management plane (M-Plane) messaging (i.e, a C-Plane messaging or an M-Plane messaging for activating (i.e., applying) an antenna array configuration change to the supported antenna array configuration).

According to the example embodiments as set forth in step 201, sleep modes may be a control plane (C-Plane) or management plane (M-Plane) compatible depending on the sleep duration.

According to an example embodiments of the Advanced Sleep Modes (ASM) having short duration (C-Plane based) sleep modes and sleep modes having a long duration (M-Plane based) sleep modes the wake-up latency (i.e., the wake-up time or the go-to-sleep time) for said ASM and the wake-up latency of the TRx control methods may be different and not interfere with (e.g., hinder) each other.

In step 205, the O-DU receives, via a response C-Plane messaging or response M-Plane messaging (i.e., a via C-Plane messaging or M-Plane messaging that is different from a C-Plane messaging or an M-Plane messaging for activating (i.e., applying) an antenna array configuration change to the supported antenna array configuration) from the O-RU. The C-Plane messaging or M-Plane messaging is a response to an antenna array configuration change to the supported antenna array configuration. In an example embodiment, the C-Plane messaging may be an acknowledgment message of the antenna array configuration change to the supported antenna array configuration. In another example embodiment, the M-Plane messaging may be a notification of the antenna array configuration change to the supported antenna array configuration.

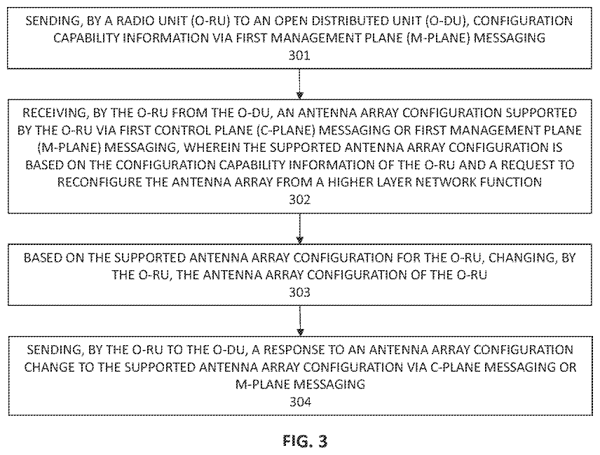

FIG. 3 illustrates the method for implementing a dynamical antenna array reconfiguration from the perspective of an O-RU. Referring to FIG. 3 the O-RU communicates (e.g., sends upon initialization and/or during operation) its configuration capability information required to perform an antenna array reconfiguration via the M-Plane to the O-DU, receives (from the O-DU) an antenna array configuration supported by the O-RU via control plane (C-Plane) messaging OR management plane (M-Plane) messaging and reconfigures the antenna array antenna model based on the supported antenna array configuration for the O-RU.

In step 301, the O-RU sends its configuration capability information via management plane (M-Plane) messaging. The O-RU configuration capability information explained in step 201 of FIG. 2 refers to step 301 in FIG. 3, respectively.

According to an example embodiment, in step 301, upon powering up, the O-RU communicates (e.g., sends) its configuration capability information required to perform an antenna array reconfiguration via the M-Plane to the O-DU. In an example embodiment, the O-RU, during start-up, exposes (reports) its capability data (including the antenna configuration capability information) to the O-DU via the Fronthaul (FH) interface to support various ES methods (e.g., TRx control methods such as, for example, the RF channel reconfiguration, antenna array selection, etc. and sleep modes such as, for example, advance sleep mode, etc.). In another example embodiment, the O-RU communicates (e.g., sends) a plurality of supported antenna models/configurations (i.e., antenna configuration capability information) through the M-Plane to the O-DU.

In another example embodiment, the O-RU, during operation, communicates (e.g., sends) its configuration capability information required to perform an antenna array reconfiguration via the M-Plane to the O-DU. For example, the higher-layer network function may perform a rollback of an ES method from an energy-saving network state to an original network state (e.g., it turns on an O-RU or parts of the O-RU). In another case, the higher-layer network function may perform a rollback of an ES method from an energy-saving network state or an original state to a high-performance network state (e.g., it switches on an idling O-RU or parts of idling O-RU to maximum performance).

According to an example embodiment, the antenna configuration capability information (O-RU antenna configuration capability information) may be hardcoded by the vendor during production along with at least one of the following parameters, a unique name, index, reference, etc. to identify the antenna array configuration capability (e.g., the technical specification of the antenna array), the number of spatial streams/layers supported against each configuration of the antenna array, the antenna calibration data to be applied by O-RU during the configuration change, a value referring to the achievable energy-savings against each configuration, associated beam weights (pre-defined beam weights), etc. In an example embodiment, when O-RU is powered on (is initialized), the O-RU starts reporting supported energy-saving modes (i.e., antenna array configuration capability information) and the hardcoded antenna array models along with the other initialization parameters to the O-DU using M-Plane yang models (e.g., an urn:o-ran:module-cap:1.0 and an urn:o-ran:hardware:1.0).

According to an embodiment, in line with the O-RAN Open Fronthaul M-Plane Specification, which defines the Management Plane of the Open Fronthaul Interface as well as associated YANG models, the O-RU may indicate the supported energy-saving features in associated YANG models a Yang Features such as, for example, o-ran-wg4-features.yang, to a lower order network function other than O-RU and/or higher order network function (i.e., an O-RU controller such as the O-DU and/or the SMO, SMO framework, etc.).

To this end, the O-DU may identify O-RU-supported feature capabilities using YANG Feature Name Tags such for example, TRX-CONTROL, TRX-ON-OFF, ADVANCED-SLEEP-MODE, SLEEP-MODE, LIGHT-HIBERNATE-SLEEP, DEEP-HIBERNATE-SLEEP, etc.

The YANG Feature Name Tags TRX-CONTROL or TRX-ON-OFF may describe the turning on/off RF channels or Tx/Rx array elements (i.e., of RF channels or Tx/Rx array elements switch on or off), whereas an M-Plane activation as an optional feature control may be not available.

The YANG Feature Name Tags ADVANCED-SLEEP-MODE or SLEEP-MODE may describe turning off carriers and associated O-RU circuit(s) and/or O-RU component(s) (i.e., muting and/switching on/off physical and functional components of the O-RU) based on the respective activated sleep mode, whereas an M-Plane activation as optional feature control may be not available.

The YANG Feature Name Tag HIBERNATE-SLEEP may describe an O-RU Energy-saving by turning off carriers and associated O-RU circuits/components for a longer duration, wherein the longer duration in comparison to other sleep modes allows an optional feature control to be implemented hardware/component/energy-saving-enabled as an M-Plane based sleep mode.

The YANG Feature Name Tag LIGHT-HIBERNATE-SLEEP may describe O-RU Energy-saving by turning off carriers and associated O-RU circuits/components for a longer duration without turning off synchronization, wherein the longer duration in comparison to other sleep modes allows an optional feature control to be implemented hardware/component/energy-saving-enabled as an M-Plane based sleep mode.

The YANG Feature Name Tag DEEP-HIBERNATE-SLEEP may describe O-RU Energy-saving by turning off carriers and associated O-RU circuits/components for a longer duration by turning off synchronization, wherein the longer duration in comparison to other sleep modes allows an optional feature control to be implemented hardware/component/energy-saving-enabled as an M-Plane based sleep mode.

According to an example embodiment, referring to the YANG Feature Name Tags ADVANCED-SLEEP-MODE or SLEEP-MODE may define various short duration (C Plane based) sleep modes, for example, the advanced sleep mode may be for shorter sleep duration like milliseconds, seconds, or minutes and activated, for example, with ST4 C Plane message by control plane (C-Plane) messaging.

According to an example embodiment, referring to the YANG Feature Name Tag HIBERNATE-SLEEP for the longer duration a hibernate-sleep mode may be activated by employing M-Plane, for example, by setting the parameter +-rw energy-saving-enabled? boolean {ENERGYSAVING}? in the respective o-ran-hardware.yang module to “True” or “Yes”.

According to an example embodiment, referring to the YANG Feature Name Tags LIGHT-HIBERNATE-SLEEP and DEEP-HIBERNATE-SLEEP in order to differentiate the longer sleep with and without turning off synchronization plane circuit, light-hibernate-sleep mode with synchronization and deep-hibernate-sleep mode without synchronization may be implemented in a same way as that of hibernate-sleep by employing the M-Plane, for example, by setting the parameter +-rw energy-saving-enabled? boolean {ENERGYSAVING}? in the respective o-ran-hardware.yang module to “True” or “Yes”.

Referring to the O-RU reporting to the O-DU and/or SMO based on yang modules such as, for example, as specified in the o-ran module.cap.yang, Advanced Sleep Modes (ASM) may support sleep modes having a short duration (C-Plane based) sleep modes (e.g., a plurality of sleep modes (SM) such as, for example, SM #0, SM #1, SM #2, SM #3, etc. wherein the time duration of SM #0<SM #1<SM #2<SM #3) with different wake-up times or if the wake-up times is too short a defined go-to-sleep time. Moreover, the Advanced Sleep Modes (ASM) may support sleep modes having a long duration (M-Plane based) sleep modes (e.g., the hibernate sleep that does not involve any synchronization or the hibernate sleep modes with or without synchronization, whereas the light hibernate sleep refers to an M-Plane based sleep mode with synchronization and the deep hibernate sleep refers to an M-Plane based sleep mode without synchronization.

According to an embodiment, the Advanced Sleep Modes (ASM) have a wake-up time (minimum or guaranteed) per sleep mode. The shortest of the C-Plane-based sleep modes (e.g., SM #0) may be not defined by a minimum or guaranteed wake-up time but by go-to-sleep time.

The O-RU reporting to the O-DU and/or SMO based on yang modules such as, for example, as specified in the o-ran module.cap.yang, may also support of C-Plane messages such as Section Type 8 (ST8) “ready” message and C-Plane messages including a command scope (e.g., CARRIER-COMMAND, ARRAY-COMMAND, O-RU-COMMAND) such as, for example, a Section Type 4 (ST4) message.

The O-RU reporting to the O-DU and/or SMO based on yang modules such as, for example, as specified in the o-ran module.cap.yang, may also support sleep duration extension and emergency wake-up by M-Plane and/or C Plane messaging.

Moreover, the O-RU reporting to the O-DU and/or SMO based on yang modules such as, for example, as specified in the o-ran module.cap.yang may also provide information such as the percentage of achievable energy-savings.

Furthermore, the O-RU reporting to the O-DU and/or SMO based on yang modules such as, for example, as specified in the o-ran module.cap.yang, may also support a notification messaging for CU plane active or inactive state, such as, for example, support a notification that may be required to ensure the CU plane become active after sleep duration expires (i.e., a CU plane circuit may be turned off in the case of defined, undefined, and/or longer sleep duration). To this end, the O-RU reporting to the O-DU and/or SMO supports notifications from O-RU to O-DU about CU plane status in case it is turned off during any of the sleep mode activations.

To this end, in the O-RU, similar to existing M-Plane models (e.g., similar to energy-saving by transmission blanks parameter that the O-RU may send to the O-DU) a modified set of parameters may be defined to enable the O-RU report energy-savings parameters e.g., energy-saving-by-rf-channel-reconfiguration, energy-saving-by-advanced-sleep-modes, energy-saving-by-modify-no-of-spatial-streams, etc. in order to report the supported energy-saving modes (i.e., antenna array configuration capability information) and the hardcoded antenna array models along with the other initialization parameters to the O-DU.

Moreover, in an example embodiment, to ensure backward compatibility, the O-RU may mark an above-mentioned energy-saving mode flag in the M-Plane yang models (e.g., an urn:o-ran:module-cap:1.0 and an urn:o-ran:hardware:1.0). to false, if O-RU does not support custom configurations or RF channel reconfigurations/antenna array selection approach for ES according to its hardcoded configuration vendor as set forth above.

According to an example embodiment, the TRx control methods to reconfigure the antenna array may include TRx control configurations that are identified by a respective unique configuration identity or name. The antenna array model of said TRx control configurations includes at least one antenna mask (antMask), wherein the antenna mask bits combination may be limited only to the supported TRx control configurations, wherein the antenna mask bits identify a ‘0’ for antenna elements to be turned off and ‘1’ for active elements of the antenna array. Moreover, TRx control configurations include in addition to the mask bits for at least one antenna mask (antMask), antenna layer mask bits for creating at least one antenna layer mask (antLayerMask).

According to an example embodiment, the supported TRx control configurations may comprise a transition time (i.e., different from a wake-up time of the ASMs) that defines a minimum or guaranteed time required to switch from baseline configuration to specific configuration (i.e., switch a baseline 64TRx antenna array to another antenna mask configuration such as, for example, a 32TRx_antenna array model). The transition time associated with each configuration change for the supported TRx control configurations and as a function of sub-carrier spacing may be, for example, for 15 KHz, one slot is 1 millisecond, for 30 KHz, one slot is 0.5 millisecond or 500 microseconds, etc.

According to an example embodiment, the TRx control methods may include control to turn on/off entire RF Transceiver chains and/or Radio Frequency Front End (RFFE) of Radio Frequency (RF) processing unit pertaining to some of the RF channels/antenna elements.

Moreover, according to another example embodiment, the TRx control methods may include control to turn on/off Components, Circuits, IPs, Cores, Computing engines of the digital baseband and O-RAN Fronthaul processing units (i.e., physical components of the O-RU).

According to embodiments of the Advanced Sleep Modes (ASM) having short duration (C-Plane based) sleep modes and sleep modes having a long duration (M-Plane based) sleep modes the wake-up latency (i.e., the wake-up time or the go-to-sleep time) for said ASM and the wake-up latency of the TRx control methods may be different and not interfere with (e.g., hinder) each other.

In step 302, the O-RU receives an antenna array configuration supported by the O-RU via control plane (C-Plane) messaging or management plane (M-Plane) messaging, wherein the supported antenna array configuration is based on the configuration capability information of the O-RU and a request to reconfigure an antenna array from a higher-layer network function. To this end, step 204 of FIG. 2 may refer to step 302 in FIG. 3, i.e., the O-DU applies the supported antenna array configuration via control plane (C-Plane) messaging or management plane (M-Plane) messaging (i.e, a C-Plane messaging or an M-Plane messaging for activating (i.e., applying) an antenna array configuration change to the supported antenna array configuration).

According to the example embodiments as set forth in step 302 (i.e., step 204 in FIG. 2), sleep modes may be control plane (C-Plane) and/or management plane (M-Plane) compatible depending on the sleep duration.

According to an example embodiments of the Advanced Sleep Modes (ASM) having short duration (C-Plane based) sleep modes and sleep modes having a long duration (M-Plane based) sleep modes the wake-up latency (i.e., the wake-up time or the go-to-sleep time) for said ASM and the wake-up latency of the TRx control methods may be different and not interfere with (e.g., hinder) each other.

According to embodiments of the TRx control methods, the antenna array configuration is commenced via control plane (C-Plane) messaging or via management plane (M-Plane) messaging.

In step 303, the O-RU changes (i.e., reconfigures) the antenna array configuration of the O-RU based on the supported antenna array configuration for the O-RU (i.e., as provided, for example, by the O-DU).

In step 304, according to an example embodiment, the O-RU sends a response to an antenna array configuration change to the supported antenna array configuration via C-Plane messaging or M-Plane messaging to the O-DU.

In an example embodiment, the C-Plane messaging may be an acknowledgment message of the antenna array configuration change to the supported antenna array configuration. In another example embodiment, the M-Plane messaging may be a notification of the antenna array configuration change to the supported antenna array configuration.

For example, the O-RU may notify a configuration change during the transition from a first antenna array configuration to a second antenna array configuration considering the transition time (i.e., wake-up time). The notification may be to the O-DU via the hierarchical architecture of the O-RAN or the higher-layer network functions (e.g., the SMO, RICs, etc.).

According to an example embodiment, the O-RU may notify an antenna array configuration change (e.g., a back configuration) during the transition from the second antenna array configuration to the first antenna array configuration considering the transition time (i.e., wake-up time). For example, the O-RU notifies the rollback configuration change during the transition from an energy-savings mode (i.e., the second antenna array configuration) to the baseline configuration (i.e., the first antenna array configuration) considering the transition time.

The method for implementing a dynamical antenna array reconfiguration within an open radio access network (O-RAN) according to FIGS. 2 and 3 may be implemented in at least one apparatus comprising a memory to store instructions and a processor configured to execute instructions.

Referring to the method and apparatus according to FIGS. 2 and 3 dynamical antenna array reconfiguration, e.g., a dynamic changing of antenna array configurations such as, for example, switching between one antenna array model to another antenna array model (i.e., muting (e.g., turning off) parts of an antenna array (i.e., antenna elements) along with their respective RF transceiver chains) has the advantage that ES methods can be implemented with maximum efficiency due to exchange of knowledge of the proprietary internal architectures (e.g., the O-RUs read-only (proprietary) parameters).

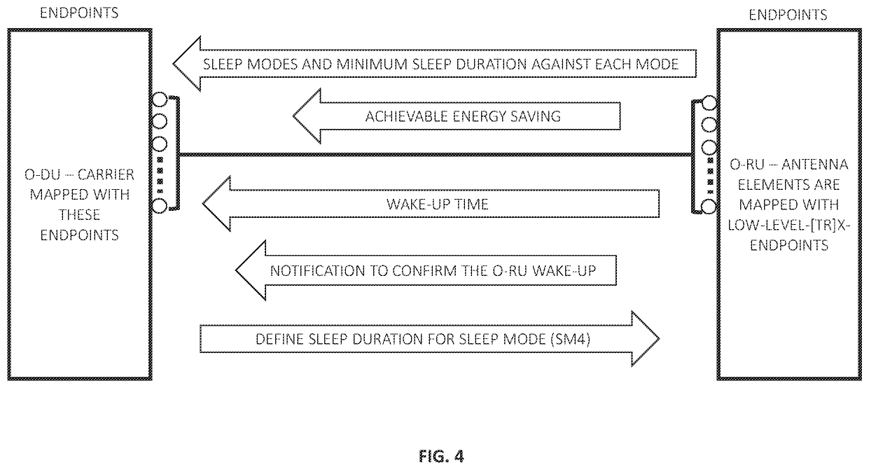

FIG. 4 illustrates a method of M-Plane messaging comprising at least one Yang model for capability reporting of sleep modes (e.g., advanced sleep modes) and associated parameters according to an embodiment. Referring to FIG. 4, the O-RU reports its capability information to implement sleep modes based on the Yang model for capability reporting of sleep modes to O-DU. Based on the sleep mode the parameters and requirements to be met by the O-RU differ. The O-DU uses the capability information to apply a supported antenna array configuration (i.e., applying a supported antenna array configuration for the respective sleep mode).

As set forth above in FIGS. 2 and 3, sleep modes may be defined as summarized in the table below.

| | Time Duration | Minimum No of Slots | | | |
|---|---|---|---|---|---|
| | (Minimum Sleep | | | | |
| Sleep Mode | Duration) | O-RU - X | | O-RU - Y | |
| Sleep Mode #0 | Symbol to Slot | — | | Not | |
| (SM0) | | | | supported | |
| Sleep Mode #1 | L Slots (1 Slot) | 1 | slot | 5 | slots |
| (SM1) | | | | | |
| Sleep Mode #2 | M Slots (Radio | 10 | slots | 15 | slots |
| (SM2) | Frame (10 ms)) | | | | |
| Sleep Mode #3 | N Slots (100 ms) | 100 | slots | 2000 | slots |
| (SM3) | | | | | |
| Sleep Mode #4 | Undefined time | 60000 | slots | 70000 | slots |
| (SM4) | (1 min) | | | | |

Referring to the above Table, 15 KHz SCS is considered for number of slots calculation.

Regarding the sleep modes (e.g., the advanced sleep modes), advanced sleep modes with minimum sleep duration may be activated and deactivated and minimum duration of against each sleep mode may be exchanged between the O-RU and the O-DU.

Regarding sleep modes, the achievable energy savings are either reported by O-RU or monitored by O-DU.

Moreover, for the sleep mode with undefined sleep (SM4) wake-up time is provided by the O-RU. Sleep mode #4 (SM4) (undefined time) may be accomplished by setting parameters “numSlots” and “sleepDepth” to zero, wherein the O-DU defines the sleep time duration.

Furthermore, regarding a sleep mode with undefined sleep (SM4), a notification for confirming the wake-up may be sent by the O-RU.

The O-DU, based on the wake-up time as informed and/or confirmed by the O-RU, the O-DU defines the wake-up time for the sleep mode with undefined sleep (SM4).

In addition, for the sleep mode with undefined sleep (SM4), a notification for CU-Plane active or inactive state may be provided by the O-DU to ensure the CU plane is active after the sleep duration expires.

According to another example embodiment for the use case, RF Channel Reconfiguration (i.e., RF Channel Switch Off/On) a sub-use case may be defined as Hibernate sleep. For this sub-use case, the O-RU receives an antenna array configuration supported by the O-RU from the O-Du via the management plane (M-Plane) messaging, wherein the supported antenna array configuration may include among other commands to activate and deactivate the O-RU at least one of a command that the O-DU sets energy-saving enabled to “True” using “o-ran.hardware.yang” module, a command that the O-DU sends the <rpc> <edit-config> <[tr]x-array-carrier:: ACTIVE> with the value “SLEEP” or “INACTIVE” to O-RU to put to sleep or deactivate the carrier. Then O-RU change the [tr]x-array-carrier:: STATE to DISABLED through BUSY, a command that the O-DU uses appropriate RPCs (i.e., <edit-config> and <delete-config> to deconfigure or remove the carrier(s) in O-RU or that the O-RU may perform this operation by itself with its internal logic during the long sleep (e.g., this command may provision more energy-saving as the associated circuits could be turned off), a command to turn off the C-Plane, U-Plane, S-Plane, and M-Plane circuits if all carriers are removed/de-configured during hibernate (long/deep) sleep, and command that the O-DU may turn off the C-Plane, U-Plane, S-Plane, and M-Plane circuits by sending appropriate commands/rpcs, a command that the O-RU itself with its internal logic may turn off the C-Plane, U-Plane, S-Plane, and M-Plane circuits, a command to turn off M-Plane (Netconf Supervision monitoring) and CU-Plane monitoring circuits (e.g., the turning off command for monitoring circuits may be applied on top of both TRx control and Advanced sleep mode-based energy-saving use cases in case of long duration energy-saving), a command that the O-RU sends a RPC reply to O-DU to indicate the correction reception of the above RPC by sending “ok”.

In an example embodiment, a Yang model for capability reporting the CU plane circuit active state (awake from sleep) may have an o-ran-module-cap.yang structure that comprises the parameter according to the following summary.

o-ran-module-cap.yang module
| +−−ro energy-saving-by-transmission-blanks boolean

| | |
|---|---|
| \| +−−ro energy-saving-by-trx-control boolean | //TRx control - various |

antenna configuration for energy-savings
| +−−ro energy-saving-by-advanced-sleep-modes boolean
| | +−−ro advanced-sleep-modes enum
| | +−−ro micro-sleep-mode-supported? Boolean //O-DU read this response (either ‘Yes' or ‘No’)
and get to know whether O-RU supports micro sleep or not - Option # 1
| | + −−−n micro-sleep-mode-supported //Notification to indicate whether micro-sleep mode
supported or not - Option #2
| +−−ro CU-plane-active-state enum //this capability to indicate CU plane circuit is awake and
active to receive messages from O-DU. For e.g., during sleep mode, CU plane circuit turned off
sometime and wake-up. With the current notification framework, only carrier active state is
being reported by O-RU to O-DU. It is required to notify O-DU that CU plane is waked up from
sleep and active beforehand, so that O-DU can start scheduling CU plane packets.
| +−−ro eaxcid-grouping-capabilities {o-ran-module-cap:EAXC-ID-GROUP-SUPPORTED}?
| | +−−ro max-num-tx-eaxc-id-groups? uint8
| | +−−ro max-num-tx-eaxc-ids-per-group? uint8

In an example embodiment, a Yang model for capability reporting the supported advanced sleep modes and associated parameter (e.g., advanced sleep modes) may be have an o-ran-module-cap.yang structure that comprises the parameter according to the following summary. o-ran-uplane-conf.yang module

The format for the userplane configuration module is provided below

```
module: o-ran-uplane-conf
+−−rw user-plane-configuration
+−−rw low-level-tx-links* [name]
| +−−rw name string
| +−−rw sro-id? −> /or-user:users/user/sro-id {feat:SHARED-ORU-MULTI-OPERATOR}?
| +−−rw processing-element −> /o-ran-pe:processing-elements/ru-elements/name
| +−−rw transport-session-type? enumeration {feat:MULTIPLE-TRANSPORT-SESSION-
TYPE}?
| +−−rw transport-qualified-processing-element? −> /o-ran-pe:processing-elements/additional-
transport-session-type-elements[o-ran-pe:transport-session-type = current( )/../transport-session-
type]/ru-elements/name {feat:MULTIPLE-TRANSPORT-SESSION-TYPE}?
| +−−rw tx-array-carrier −> /user-plane-configuration/tx-array-carriers/name
//advanced sleep modes
+−−ro advanced-sleep-modes-types
| +−−ro sleep-mode#0: SM0 string
| | +−−ro sleep-duration:tsleep decimal64/uint16 // Sleep duration range (Tsleep)= symbol to Tₛₗₒₜ,
  where Tslot is slot time in microseconds
| | | +−−ro minimum-sleep-duration decimal/uint16 // symbol time
| | +−−ro achievable-energy-saving decimal64 // achievable energy-savings based on O-RU
  design, sleep mode, and environmental condition
| +−−ro sleep-mode# 1: SM1 string
| | +−−ro sleep-duration:tsleep decimal/uint16 // Sleep duration range (Tsleep)= Tslot to 10ms
```

| | |
|---|---|
| \| \| \| +−−ro minimum-sleep-duration decimal/uint16 | // Tslot - slot time in |

```
  microseconds
| | +−−ro achievable-energy-saving decimal64 // achievable energy-savings based on O-RU
  design, sleep mode, and environmental condition
| +−−ro sleep-mode#2: SM2 string
| | +−−ro sleep-duration:tsleep decimal/uint16 // Sleep duration range (Tsleep)= 10ms to 100ms
| | | +−−ro minimum-sleep-duration decimal/uint16 // 1 Radio frame (10ms)
| | +−−ro achievable-energy-saving decimal64 // achievable energy-savings based on O-RU
  design, sleep mode, and environmental condition
| +−−ro sleep-mode# 3: SM3 string
| | +−−ro sleep-duration:tsleep decimal/uint16 // Sleep duration range (Tsleep)= 100 ms to 1 min
```

| | |
|---|---|
| \| \| \| +−−ro minimum-sleep-duration decimal/uint16 | // 100ms |

```
| | +−−ro achievable-energy-saving decimal64 // achievable energy-savings based on O-RU
  design, sleep mode, and environmental condition
| +−−ro sleep-mode#4: SM4 string
| | +−−ro sleep-duration:tsleep decimal/uint16 // Sleep duration range(Tsleep)= undefined time (to
  be defined by O-DU)
```

| | |
|---|---|
| \| \| \| +−−ro minimum-sleep-duration decimal/uint16 | // 1 minute |

```
| | +−−ro wake-up-timedecimal64 //wakeup time range based on O-RU design, sleep mode
  duration, and environmental condition
| | +−−ro achievable-energy-saving decimal64 // achievable energy-savings based on O-RU
  design, sleep mode, and environmental condition
| +−−rw low-level-tx-endpoint −> /user-plane-configuration/low-level-tx-endpoints/name
+−−rw low-level-rx-links* [name]
| +-rw name string
```

According to embodiments of the Advanced Sleep Modes (ASM) having short duration (C-Plane based) sleep modes and sleep modes having long duration (M-Plane based) sleep modes the wake-up latency (i.e., the wake-up time or the go-to-sleep time) for said ASM and the wake-up latency of the TRx control methods may be different and not interfere with (e.g., hinder) each other.

Moreover, regarding common capability parameters to be reported by O-RU configuration capability information to the O-DU via an M-Plane for both TRx control methods and sleep modes (e.g., advanced sleep modes) may include C-Plane ST8 “ready” messages and sleep duration extension (e.g., in case of defined sleep, if the O-DU needs to extend a sleep mode it send a sleep extension command just before the start of wake-up time). In case the CU-Plane remains active, the extension command may be C-Plane-based for short sleep durations. In case the CU-Plane is turned off the extension command may be M-Plane based for long sleep durations.

Furthermore, regarding the common capability parameters to be reported by O-RU, the configuration capability information (to the O-DU via an M-Plane) for both TRx control methods and sleep modes (e.g., advanced sleep modes) may include an emergency wake-up of O-RU from sleep. This capability may be reported by O-RU via the M-Plane (i.e., an M-Plane command). For example, in case of sleep mode interruption, if the O-DU needs to interrupt a sleep mode it sends a sleep mode interruption command. In case the CU-Plane remains active, the emergency wake-up command may be C-Plane based for short sleep durations (defined or undefined). In case the CU-Plane is turned off the emergency wake-up command may be M-Plane based for long sleep durations (defined or undefined).

According to an example embodiment, the o-ran-module-cap.yang among other YANG models for CU-Plane status reporting (e.g., to implement O-RU capabilities for defined and undefined sleep modes). The o-ran-module-cap.yang comprises information to enable a CU Plane circuit to be turned off to attain additional energy-saving. The information may include a name identifier and a status identifier of the Rx-array-carriers as well as a name identifier, action identifier and state for the cu-plane in order to report the user plane configuration. Based on the above information, the O-DU may turn on or wake-up the CU-Plane circuit through the M-Plane. According to an example embodiment, a notification is needed to indicate if CU-Plane becomes active or not (wake-up from sleep), the same may be defined in the o-ran-uplane.yang, respectively.

In an example embodiment, a Yang model for capability reporting the notification to indicate the CU plane is active from sleep may have an o-ran-module-cap.yang structure that comprises the parameter according to the following summary.

o-ran-uplane-conf.yang module
notifications:
+−−−n tx-array-carriers-state-change
| +−−ro tx-array-carriers* [name]
| +−−ro name −> /user-plane-configuration/tx-array-carriers/name
| +−−ro state? −> /user-plane-configuration/tx-array-carriers/state
+−−−n rx-array-carriers-state-change
+−−ro rx-array-carriers* [name]
+−−ro name −> /user-plane-configuration/rx-array-carriers/name
+−−ro state? −> /user-plane-configuration/rx-array-carriers/state
+−−−n cu-plane-state-change
| +−−ro cu-plane [name]
| +-ro state? −> /user-plane-configuration/cu-plane/state; The state can be active, sleep, and
inactive/disabled

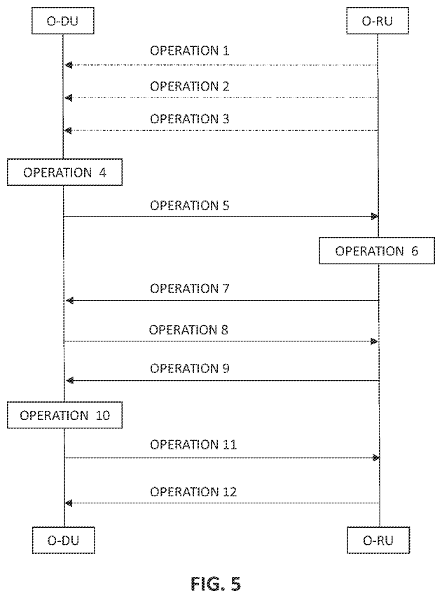

FIG. 5 illustrates a flowchart for M-Plane/C-Plane messaging between an O-RU and an O-DU for the use case of sleep modes. Referring to FIG. 5, in operation 1, the O-RU provides the O-DU with a list of supported sleep modes (e.g., Advanced Sleep Modes) along with minimum sleep duration thereof (i.e., configuration capability information reported by the O-RU to the O-RU via an M-Plane messaging may comprise a list of supported sleep modes (e.g., Advanced Sleep Modes) along with minimum sleep duration.

In operation 2, the O-RU provides the O-DU with the achievable energy-savings for each sleep mode (e.g., each sleep mode provided in operation 1 may refer to an array configuration).

In operation 3, for the case of a sleep mode with undefined sleep (i.e., for SM4), the O-RU provides the O-DU with a wake-up time from a sleep state to an active state for the undefined sleep (i.e., for the sleep mode SM4).

In general, operations 1 to 3 as set forth above refer to the O-RU capability reporting to the O-DU (i.e., to the receiving of configuration capability information of the O-RU by the O-DU).

In operation 4, the O-DU maps the reported Sleep Modes, whereas the Sleep Modes are mapped to (i.e., defined by) the C-Plane parameter “sleepMode”. Moreover, the O-DU maps the reported sleep duration and sleep mode (i.e., except indefinite/undefined sleep mode) to C-Plane parameters “sleepDur” and “Mul”, respectively. The parameter “Mul” is employed to have flexibility in sleep duration within the range of a particular sleep mode supported by O-RU. The C-Plane parameter “sleepMode”, “sleepDur” and “Mul” may be defined in fields in a ST4 CMD TYPE message referring to Advanced Sleep Modes.

In operation 5, the O-DU sends an ST4 message (“sleepMode” and “Tsleep”) to O-RU and activates the sleep with a specific time duration (based on the adopted sleep mode). The dispatch of the ST4 message (“sleepMode” and “Tsleep”) is based on a higher-layer network function request or the O-DU itself decides to activate sleep mode.

In operation 6, the O-RU receives the sleep command through an ST4 message with a definite duration and processes it. In an example embodiment, for a sleep mode with an indefinite sleep, the O-DU may send a sleep mode activation request to O-RU through the ST4 (C Plane) message or via an M-Plane messaging (i.e., carrier deactivation).

In operation 7, the O-RU provides the O-DU with O-RU sends a notification to confirm the successful/failure of sleep mode activation to the O-DU.

In operation 8, in case a failure occurs during sleep mode activation, the O-DU either retries sleep mode activation or takes appropriate action (e.g., reports to higher-layer network functions, commence a fail-safe procedure, etc.). In an example embodiment, according to the action of O-DU in case of a failure, the O-RU may respond to the actions requested by O-DU in operation 8.

In operation 9, the O-RU provides the O-DU with O-RU reports the power consumption using the performance counter “epe-stats” via an M-Plane based on the O-DU subscribing to O-RU for this “epe-stats” counter.

In operation 10, O-DU monitors the power consumption during each sleep mode/sleep duration. Moreover, the O-DU either forwards the power consumption data to higher layers or calculates the energy savings per sleep mode for future reference.

In operation 11, O-DU sends a wake-up command to O-RU to deactivate the sleep mode.

In operation 12, the O-RU sends a notification to confirm the successful deactivation of sleep mode and becomes active. In general, this notification refers to a notification for reporting the change of an array configuration change from a first array configuration to a second array configuration or vice-versa.

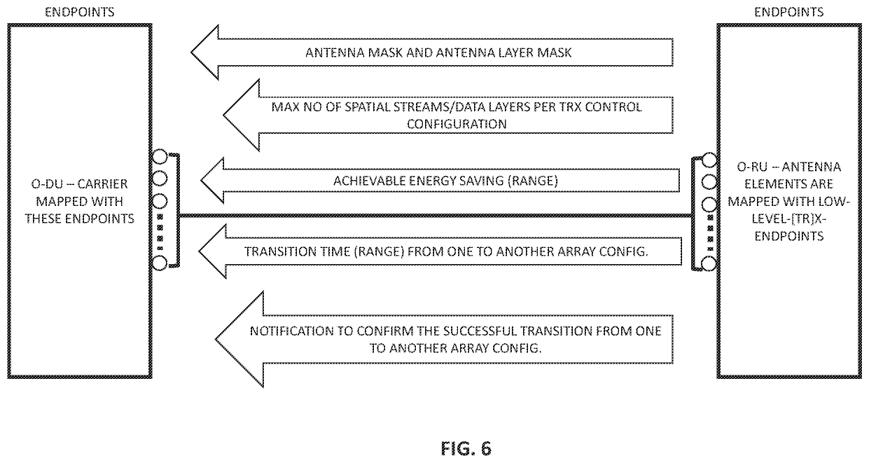

FIG. 6 illustrates a method of M-Plane messaging comprising a Yang model for FIG. 6 illustrates a method of M-Plane messaging comprising a Yang model for capability reporting of TRx control parameters along with a Yang model for capability reporting of data layer control parameters.

Referring to FIG. 6, the O-RU reports its capability information to implement TRx control based on the Yang model for capability reporting of TRx control methods to O-DU. Based on the TRx control parameters and requirements to the O-RU differ. The O-DU uses the capability information to apply a supported antenna array configuration (i.e., applying a supported antenna array configuration for the respective TRx control method (i.e., TRx control process).

In general, the o-ran-module-cap.yang relates to common O-RU capabilities (i.e., O-RU configuration capability information for sleep modes (e.g., advanced sleep modes), CU-Plane status reporting to implement the sleep modes (e.g., advanced sleep modes) and TRx control methods.

To this end, the o-ran-module-cap.yang among other YANG models may comprise all necessary information to implement an antenna array configuration supported by the O-RU (i.e., based on said O-RU configuration capability information).

According to an example embodiment, the o-ran-module-cap.yang among other YANG models for TRx control methods to reconfigure the antenna array may include TRx control configurations that are identified by a respective unique configuration identity or name. The antenna array model of said TRx control configurations includes at least one antenna mask (antMask), wherein the antenna mask bits combination may be limited only to the supported TRx control configurations, wherein the antenna mask bits identify a ‘0’ for antenna elements to be turned off and ‘1’ for active elements of the antenna array. Moreover, TRx control configurations include in addition to the mask bits for at least one antenna mask (antMask), antenna layer mask bits for creating at least one antenna layer mask (antLayerMask).

According to an example embodiment, the TRx control methods may include control to turn on/off entire RF Transceiver chains and/or Radio Frequency Front End (RFFE) of Radio Frequency (RF) processing unit pertaining to some of the RF channels/antenna elements.

Moreover, according to another example embodiment, the TRx control methods may include control to turn on/off Components, Circuits, IPs, Cores, Computing engines of the digital baseband and O-RAN Fronthaul processing units (i.e., physical components of the O-RU).

According to an example embodiment for the use case RF Channel Reconfiguration (i.e., RF Channel Switch Off/On) a sub-use case may be defined as TRx Control (i.e., a Tx array control and Rx array control may be claimed separately since antenna masks may be defined per array level. For this sub-use case, the O-RU may include at least one of the following capability reporting (i.e., configuration capability information). The configuration capability information may include among other capability reporting at least the reporting of support of a C-Plane and an M-Plane based TRx control activation/deactivation, the reporting of a list of supported antenna array configuration/TRx control configurations (e.g., valid Antenna mask values (per antenna array configuration values) along with an index and/or an unique name, the reporting of wake-up time/duration as a function of SCS (Sub-carrier spacing) (i.e., this wake-up may be different from the wake-up time/duration reported for Advanced sleep mode), the reporting of the support of TRx control sleep modes, the reporting of the amount of achievable energy-saving/power saving/energy-saving ratio per antenna array configuration (Tx array and/or Rx array) or TRx control (Tx control and/or Rx control), the reporting of the support of defined and undefined duration sleep, ST8 ready message, sleep duration extension, and emergency wake-up and the reporting of the O-RU internal architecture (functional blocks) using valid yang data model parameters to attain maximum energy-savings (i.e., exposing the O-RU internal architecture).

The reporting of energy-saving by TRx control may be reported by parameters of a Yang model o-ran-module-cap.yang according to the following summary:

o-ran-module-cap.yang module
| | +−−ro number-of-guard-rbs-dl? uint8
| +−−ro energy-saving-by-transmission-blanks boolean

| | |
|---|---|
| \| +−−ro energy-saving-by-trx-control boolean | //TRx control - various |

antenna configuration for energy-savings
| +−−ro energy-saving-by-advanced-sleep-modes boolean
| | +−−ro advanced-sleep-modes enum
| | +−−ro micro-sleep-mode-supported? Boolean //O-DU read this response (either ‘Yes' or ‘No’)
and get to know whether O-RU supports micro sleep or not - Option #1
| | +−−−n micro-sleep-mode-supported //Notification to indicate whether micro-sleep mode
supported or not - Option #2
| +−−ro CU-plane-active-state enum //this capability to indicate CU plane circuit is awake and
active to receive messages from O-DU. For example, during sleep mode, CU plane circuit turned
off sometime and wake-up. With the current notification framework, only carrier active state is
being reported by O-RU to O-DU. It is required to notify O-DU that CU plane is waked up from
sleep and active beforehand, so that O-DU can start scheduling CU plane packets.

According to another example embodiment for the use case RF Channel Reconfiguration (i.e., RF Channel Switch Off/On) a sub-use case may include the capability reporting (i.e., configuration capability information) of the O-RU that supports a list of maximum supported spatial streams/data layers per antenna array (TRx Control) configuration. For example, this a sub-use case may be defined as Data Layer Control.

According to another example embodiment for the use case of Advanced Sleep Modes, the O-RU may include at least one of the following capability reporting (i.e., configuration capability information). The configuration capability information may include among other capability reporting at least the reporting of a wake-up duration associated with each sleep mode as a function of the SCS, the reporting of the amount of achievable energy-saving per sleep mode type, the reporting of the support of defined and undefined duration sleep, ST8 ready message, sleep duration extension, and emergency wake-up.

According to an example embodiment, the supported TRx control configurations may comprise a transition time (i.e., different from a wake-up time of the ASMs) that defines a minimum or guaranteed time required to switch from baseline configuration to specific configuration (i.e., switch a baseline 64TRx antenna array to another antenna mask configuration such as, for example, a 32TRx_antenna array model). The transition time (i.e., wake-up time) associated with each configuration change for the supported TRx control configurations and as a function of sub-carrier spacing may be, for example, for 15 KHz, one slot is 1 millisecond, for 30 KHz, one slot is 0.5 millisecond or 500 microseconds, etc.

The Yang model o-ran-module-cap.yang may include the parameters according to the following summary.

TRx control configurations and associated parameter reporting - o-ran-uplane-conf.yang
| +−−rw name string
| +−−rw sro-id? −> /or-user:users/user/sro-id {feat:SHARED-ORU-MULTI-OPERATOR}?
| +−−rw processing-element −> /o-ran-pe:processing-elements/ru-elements/name
| +−−rw transport-session-type? enumeration {feat:MULTIPLE-TRANSPORT-SESSION-
TYPE}?
| +−−rw transport-qualified-processing-element? −> /o-ran-pe:processing-elements/additional-
transport-session-type-elements[o-ran-pe:transport-session-type = current( )/../transport-session-
type]/ru-elements/name {feat:MULTIPLE-TRANSPORT-SESSION-TYPE}?
| +−−rw tx-array-carrier −> /user-plane-configuration/tx-array-carriers/name
//trx control
| +−−ro trx-control-configurations
//antenna mask and no of antenna layers reporting
| | +−−ro antLayerMask unint 16 // no of antenna layers to be reported by O-RU vendor
| | +−−ro antMask unint32 // all supported configurations have antenna mask lists consists of
[0, 1, ... ... x] matrix −> this will be mapped with 1s (for antenna elements to be turned off) and
0s (For active antenna elements)); If antMask bits beyond total no of antenna elements, the
remaining bits to be set as zero so that O-DU ignore those additional bits
| | | +−−ro x decimal64// no of TRx
//reporting of achievable energy-saving against each trx control antenna configuration
//Option #1
| | +−−ro achievable-energy-saving-range decimal64 //list that contains the energy-saving values
calculated (based on power consumption against each configuration)for all TRx control
configurations under different environmental conditions; these information to be shared by O-
RU vendor as it is design specific
//Option # 2
| | +−−ro achievable-energy-saving-trx-control decimal64 //list that contains best possible
energy-saving achievable for all supported configurations
//reporting of transition time against each trx control antenna configuration
| | +−−ro transition-time decimal64 //list that contains transition time achievable for all
supported configurations depending on the environmental condition and based on no of trx
channel On/Off; in terms of symbols, slots, ms, sec, mins, hours
//notification to ensure the transition from one trx control antenna configuration to another
| | +−−−n trx-control-configuration-state-change //Notification to confirm the successful transition
(Active state-change by O-RU) from one configuration to another or baseline so that O-DU can
schedule data according to the present configuration.
//data-layer/spatial streams control
| +−−ro max-no-of-spatial-streams-per-trx-control-configuration unint32 // limiting the no of
spatial streams/data layers per TRx control configurations
| | +−−ro achievable-energy-saving-spatial-streams-control decimal64 // energy-saving by
data layers/spatial streams control on top of TRx control configurations

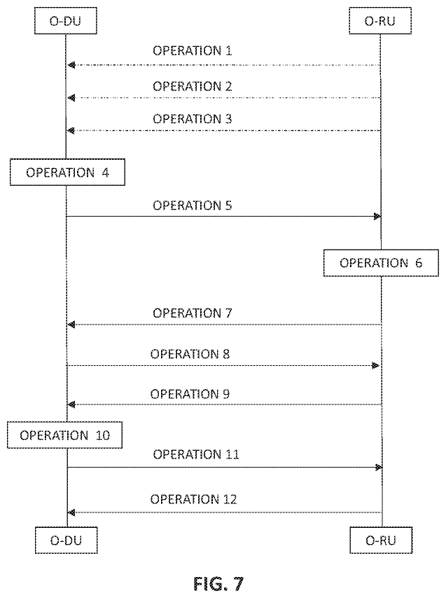

FIG. 7 illustrates a flowchart for M-Plane/C-Plane messaging between an O-RU and an O-DU for the use case of TRx control. Referring to FIG. 7, in operation 1, the O-RU provides the O-DU with M-Plane messaging parameter (i.e., Yang model parameters) “antMask” and “antLayerMask” based on the TRx control configurations and/or antenna models supported by the O-RU (i.e., configuration capability information may comprise TRx control configurations and/or antenna models).

In operation 2, the O-RU provides the O-DU with achievable energy-savings per configuration (i.e., array configuration such as TRx control configurations, antenna models, etc.).

In operation 3, the O-RU provides the O-DU with the transition time for switching from one configuration (i.e., array configuration such as TRx control configurations, antenna models, etc.) to another or rolling back to a baseline configuration.

In general, operations 1 to 3 as set forth above refer to the O-RU capability reporting to the O-DU (i.e., to the receiving of configuration capability information of the O-RU by the O-DU).

In operation 4, O-DU updates the number of bits (x) to represent the parameter “antMask” (e.g., if the O-RU reports 64TRx (baseline configuration) the parameter antMask has the value [5:0]. Moreover, the O-DU stores the number of TRx configurations supported by the O-RU, the transition time thereof, and the approximate energy-saving per configuration as reported by the O-RU in operations 1 to 3. In an example embodiment, referring to bit masking of the antenna array the total number of TRxs (antennas) may refer to a parameter having a value [0, 1, 2, 3, 4, 5, 6, 7, . . . x]. A parameter referring to a baseline antenna configuration may have the value [0, 0, 0, 0, 0, . . . x], wherein “0” value denotes an active element and “1” value denotes a deactivated element (i.e., an element to be turned off). Moreover, a parameter referring to a TRx control configuration may have a value of [1, 1, 1, 1, 1, 0, 0, 0, 0, 0, . . . x], wherein “0” value denotes an active element and “1” value denotes a deactivated element (i.e., an element to be turned off).

In operation 5, based on a higher-layer network function request, the O-DU activates the specific antenna configuration for a definite or undefined time duration.

In operation 6, the O-RU configures the TRx corresponding to antMask bits. To this end, TRx elements assigned to ‘0’, to turn off/keep inactive/put to sleep and ‘1’ for turn on/keep active with associated circuits or components (e.g., RF components such as RF Transceiver and RF channels (PA/LNA, etc., digital components, base band components, etc.). Furthermore, according to an example embodiment, the O-RU may wait for message and/or commands via the C-Plane or the M-Plane for further action.

In operation 7, the O-RU provides the O-DU with O-RU sends the notification conform the successful/failure of a transition from one TRx control configuration to another TRx control configuration or a rollback to a baseline configuration (i.e., a report of a change of array configuration from a first array configuration to a second array configuration or vice versa.

In operation 8, in case a failure occurs during configuration change, the O-DU either retries or rolls back to a working configuration (i.e., the current configuration) or takes appropriate action (e.g., report to higher-layer network functions and/or commence fail-safe procedures).

In operation 9, the O-RU reports the power consumption using the performance counter “epe-stats”.

In operation 10, O-DU monitors the power consumption for both baseline configuration and TRx control antenna configuration. Moreover, the O-DU either forwards the power consumption data to a higher-layer network function or calculates the energy-savings per configuration for future reference.

In operation 11, once network usage becomes normal, the O-DU sends an ST4 message, where the antMask with all ones to bring back the baseline antenna configuration.

In operation 12, the O-RU sends the notification to confirm the successful transition to baseline antenna configuration.

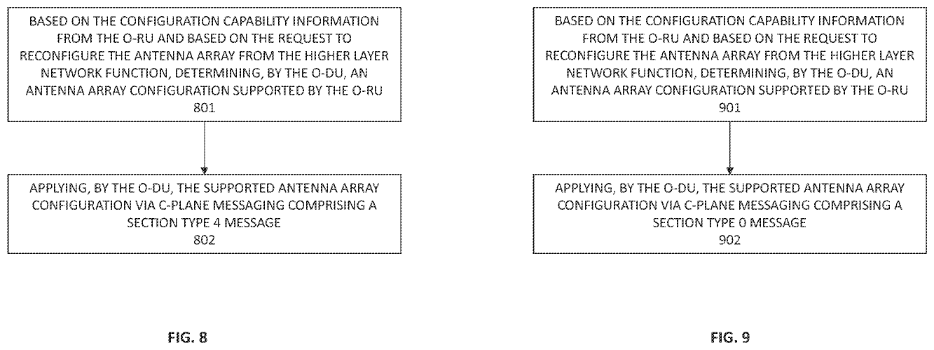

FIG. 8 illustrates a method implementing a TRx control process via at least one Section Type 4 message in the C-Plane according to an embodiment.

Referring to FIG. 8, in step 801, the O-DU determines an antenna array configuration supported by the O-RU based on the configuration capability information from the O-RU and based on the request to reconfigure the antenna array from the higher-layer network function.

In step 802, the O-DU applies the supported antenna array configuration via C-Plane messaging comprising a Section Type 4 message.

In another example embodiment, the O-DU may use a C-Plane ST 4 message together with at least one of a SE 10, 11, 16, and 19 message wherever required (e.g., during run time) to apply the a (new) antenna array model to the O-RU. In particular, the O-DU may use the ST 4 command type (ST4CmdType) to apply configuration sets (i.e., a particular antenna model/configuration).

In an example embodiment, according to the C-Plane ST 4 message, the of C-Plane ST 4 message the O-DU uses the specified slot level configuration to apply single/multiple endpoints by employing a common Section Type 4 header followed by single/multiple Section Type 4 command(s) (e.g., ST4CmdType(s)), whereas each of the Section Type 4 commands is used to specify a configuration command that applies to a particular slot.

In another example embodiment, according to the C-Plane ST 4 message together with a Section Extension (SE) 10, the O-DU uses the Section Extension 10 to apply Section Types 1, 3 and 5. To this end, the O-DU utilizes the C-Plane section information for the multiple ports (i.e., layers or Tx/Rx paths) that may be similar except for the beam Identifications (IDs) or User Entity (UE) IDs. As a result, when multiple ports share common section information within the O-RU, the O-DU sends C-Plane sections via corresponding ports (RU_ports) that are merged into one C-Plane section via representative ports using Section Extension 10. On the O-DU side, the O-DU via the M-Plane pre-configures said representative ports by grouping the ports to be merged to represent said ports (at the O-RU). For example, in the case of a C-Plane messaging using an ST4, Section Extension (SE) 10, the O-DU may use a unique eAxC_IDs to address each layer or spatial stream when sending C-Plane and U-Plane messages to the O-RU. Moreover, the SE 10 may be used along with a ‘representative eAxC_ID’ (configured via an M-Plane) to reduce the C-Plane overhead of sending multiple messages by sending one single C-Plane message.

In yet another example embodiment, according to the C-Plane ST 4 message together with a Section Extension (SE) 11, the O-DU uses the Section Extension (SE) 11 to apply flexible beamforming weights to the O-RU. The SE 11 enables the O-DU to provide different beamforming weights for different Physical Resource Blocks (PRBs) within one section to facilitate (e.g., zero-forcing precoding). To this end, the O-DU provides the Number of bundled PRBs per beamforming weights (numBundPrb) parameter that informs the O-RU how many PRBs are bundled together and shares the according beamforming weights.

In another example embodiment, to enable the O-DU to make use of SE 11 as set forth above, the optional “little endian byte order” may be applied to beamforming. weight. in-phase. value/beamforming. weight. q-phase. value (bfwI/bfwQ) fields (i.e., I/Q beamforming weights fields) if chosen via an M-Plane. In this case, C-Plane ST 4 message together with Section Extension 11 only applies to C-Plane Section Types 1 and 3, respectively.

In yet another example embodiment, according to a C-Plane ST 4 message together with a Section Extension (SE) 16, the O-DU applies antenna mapping in UE channel information-based UL beamforming to the O-RU. Section Extension (SE) 16 may also apply to C-Plane ST 5 messages. Section Extension (SE) 16 includes a bitmask per RX endpoint to indicate the antennas to be pre-combined into the RX endpoint (i.e., eAxC_ID). According to this example embodiment, O-DU may use Section Extension (SE) 16 together with Section Extension 10. In this case, Section Extension (SE) 16 includes a list of the bitmasks to indicate the number of RX endpoints used in Section Extension 10.

In yet another example embodiment, according to a C-Plane ST 4 message together with a Section Extension (SE) 19, the O-DU applies compact beamforming information for multiple antenna ports (i.e., ‘port’ in the context of this Section Extension 19 refers to logical antenna port) to control the TRx. Section Extension 19 may also apply to C-Plane Section Types (ST) 1 and 3. According to this example embodiment, the O-DU uses Section Extension 19 for sending compact beamforming information for multiple antenna ports. For example, “little endian byte order” may applied to bfwI/bfwQ fields in SE 19. As a result, considering a large number of Channel State Information Reference Signal (CSI-RS) ports and multiple Channel State Information (CSI) resource sets the use of SE 19 has benefits for the Channel State Information Reference Signal (CSI-RS) channel messaging.

In yet another example embodiment, the O-DU may utilize C Plane ST 0 messages to specify a set of antenna elements to be muted (i.e., to apply a (new) antenna array model to be implemented by the O-RU). To this end, unused Blocks or Symbols of the existing Uplink (UL) and Downlink (DL) C-Plane ST 0 messages may be utilized by the O-DU to communicate (apply) (new) antenna array model(s) to be implemented by the O-RU (e.g., to specify the set of antenna elements to be muted). The utilization of C-Plane ST 0 messages has the advantage that the antenna elements of an antenna array may be muted for a longer duration in comparison to other C-Plane messages such as, for example, ST 4 together with at least one of a SE 10, 11, 16, and 19 message because the C-Plane ST 0 messages can be used to dynamically update the antenna array configuration (i.e., dynamically update/generate at least one antenna model comprising the beam weight(s) and/or the necessary antenna calibration of said at least one antenna model)

As a result, a set of specified antenna elements can be muted for a longer time to achieve maximum energy-savings by employing the C-Plane ST 0 messages.

Furthermore, in an alternative example embodiment, according to a C-Plane ST 4 message, the O-DU may achieve a sustaining antenna array configuration application may be implemented by numslots commands for long-time energy-savings. According to this embodiment, the O-DU, C-Plane ST 4 messages, applies commands to multiple endpoints/eAXC IDs (i.e., array for TD beamforming). To this end, the numslots command is used in C-Plane ST4 messages to specify the number of slots for which an operation (i.e., power save mode) is to be performed.

FIG. 9 illustrates a method implementing a TRx control process via Section Type 0 Message in the C-Plane according to an embodiment.

Referring to FIG. 9, in step 901, the O-DU determines an antenna array configuration supported by the O-RU based on the configuration capability information from the O-RU and based on the request to reconfigure the antenna array from the higher-layer network function.

In step 902, the O-DU applies the supported antenna array configuration via C-Plane messaging comprising at least one of a Section Type (ST) 0 message together with a Section Extension (SE) 7 message (e.g., a command field in a SE 10 together with an ST 0 message specifying the Transceiver (TRx) control parameters to reconfigure the antenna array and an energy-saving duration to be applied to the O-RU via the C-Plane.

In an example embodiment the O-DU may indicate to the O-RU that certain resource blocks or symbols are not to be used (e.g., the O-DU may create idle periods, guard periods, etc.) in said C-Plane Section Type messages (e.g., a ST 0 or ST 4 messages). Moreover, the O-DU may utilize non-associated (i.e., reserved or not yet defined) U-Plane messages containing IQ samples (data) for the Section Types (ST 0, ST 4) as set forth above (i.e., at least one of a C-Plane Section Type 0 or Section Type 4 together with at least one of a Section Extensions 10, 11, 16, 19, etc. messages).

In any case, the purpose of using existing, but unused resource blocks or symbols of C-Plane Section Type messages is to inform (apply to) the O-RU that RF signal transmissions (e.g., the radiation of RF signals by certain antenna elements in an antenna array) may be halted during the specified idle interval (e.g., to conserve power or to provide an interval for calibration).

To this end, according to the example embodiment, the O-DU may send, via the C-Plane, at least one message that includes at least one Section Type 0 message together with a Section Extension (SE) 7, 10, 11, 16, 19, etc. message.

In an example embodiment, the O-DU may apply a new antenna array model by using Section Extension (SE) 7, messages along with Section type 0 messages, which is used for the masking/blanking/muting of antenna elements with the existing spec (e.g., SE7, mask the part of eAXC ID designated by the ST 0 messages) in existing specification.

Moreover, in another example embodiment, in order to mute the antenna elements for a longer duration, C Plane Section type 0 messages can be used to specify a set of elements that are muted for a longer duration. Section type 0 messages are used to specify unused Blocks or Symbols in UL and DL.

The O-DU may indicate to the O-RU that certain Resource Blocks or symbols will not be used (idle periods, guard periods). Likewise, there are no associated U-Plane messages containing IQ data for this Section Type. The purpose is to inform the O-RU that transmissions may be halted during the specified idle interval (e.g., power-savings or to provide an interval for calibration). To this end, C-Plane messaging may specify antenna elements to be muted for a longer time to save energy by employing section type 0 messages.

According to an example embodiment, an antenna element may be masked or muted by not assigning beam weights or beam ‘0’ to the respective antenna elements by respective C-Plane messages. Such C-Plane messaging is possible by symbol by symbol, slot by slot or PRB by PRB (i.e., for shorter duration energy-saving mode as done TDD mode, where Tx chains are switched off during UL).

In addition, by sharing the duration along with C plane messaging, the masking or muting by C Plane messaging may be extended to a longer duration energy-saving mode as well.

In an example embodiment, the O-DU may apply an antenna array configuration for example, for TRx control methods or sleep modes by using an existing specification (messaging protocol) of the CUS Plane.

Referring to FIG. 8 and FIG. 8, the C-Plane Messaging provides capabilities for a plurality of use cases. Based on the use case, the capabilities may include C-Plane messaging to implement the antenna array configurations at the O-RU.

According to an example embodiment for the use case RF Channel Reconfiguration (i.e., RF Channel Switch Off/On) a sub-use case may be defined as TRx Control (i.e., a Tx array control and Rx array control may be claimed separately since antenna masks may be defined per array level. For this sub-use case, the O-RU may include at least one of the following activation/deactivation capabilities that may include C-Plane messaging for the activation of Tx control and Rx control via ST4 C Plane message, which contains an appropriate antenna mask value and sleep mode type, C-Plane messaging that supports “numSlots” and “numSlotsExt” fields in ST4 C Plane message to indicate the time duration for which antenna array configuration (antenna mask) is active with the respective sleep mode, C-Plane messaging that supports “numSlots” and “numSlotsExt” that together provision short and long duration sleep, C-Plane messaging that supports a symbol mask that refers to a ST8 based acknowledgment to indicate the correct reception of ST4 C Plane message for the activation of specific RF Channel Switch On/Off (TRx control and/or Data layer control) and/or Advance sleep mode, and a C-Plane messaging that supports a ST8 READY message to indicate the O-RU become active after waking up from undefined sleep duration.

According to another example embodiment for the use case RF Channel Reconfiguration (i.e., RF Channel Switch Off/On) a sub-use case may be defined as Data layer Control. For this sub-use case, the O-RU may include at least one of the following activation/deactivation capabilities that may include C-Plane messaging for activation of data layer control using ST4 C Plane message, where ST4 message field has mask bits to activate/modify the number of data layers/spatial streams for a given antenna array configuration to save additional energy, C-Plane messaging for the use case to reduce the number of spatial streams/data layers for a given antenna array configuration (e.g., 64T64R can support 16 spatial streams, but traffic/throughput/KPI requirements may restrict the number of spatial streams to 8/4/2 etc.), C-Plane messaging for the use cases of modifying/activating the number of spatial streams per TRx control configuration (e.g., the antenna array) based on the capability reported via the M-Plane (e.g., a 64T64R antenna array may support 16 spatial streams, when it is switched to 32T32R antenna array that supports 8 spatial streams, wherein this number of spatial streams may a reference for the O-DU to activate only 8 spatial streams when switching from 64T64R to 32T32R).

According to another example embodiment for the use case, RF Channel Reconfiguration (i.e., RF Channel Switch Off/On) a sub-use case may be defined as Advanced Sleep Mode. For this sub-use case, the O-RU may include at least one of the following activation/deactivation capabilities that may include C-Plane messaging for sleep mode to be activated by an ST4 C-Plane message, wherein the ST4 C-Plane message may include fields like “sleepMode” to indicate specific sleep mode and “numSlots” and “numSlotsExt” to indicate the time duration for which specific sleep mode to be activated.

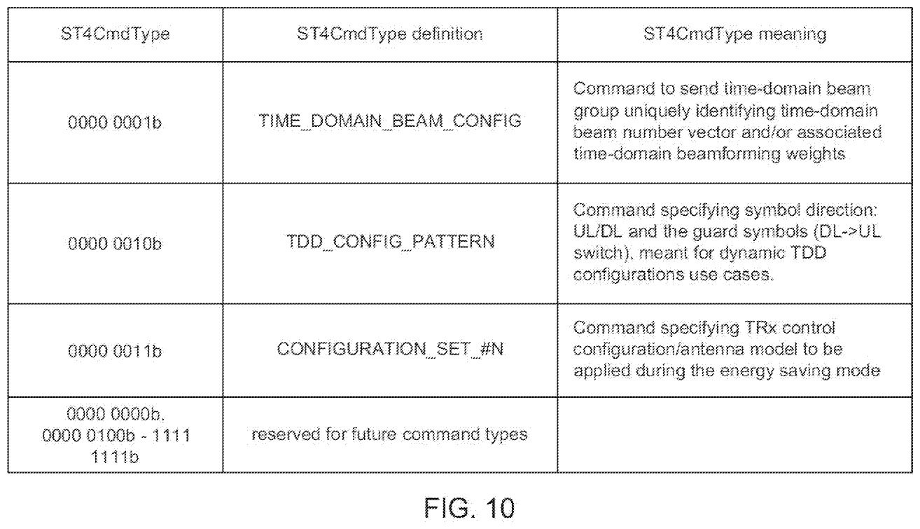

FIG. 10 illustrates a parameter for selecting antenna array reconfiguration using a Section Type 4 (ST4) message according to an embodiment. Referring to FIG. 10, the field type of an ST4 message used for selecting antenna array reconfiguration may be an ST4 Command Type (ST4CmdType). In the C-Plane, the ST4CmdType message is used to convey control information between network functions (i.e., O-RU, O-DU, etc.). For example, in an ST4CmdType message, particular fields may be reserved for control commands.

To this end, ST4CmdType field 0000 0001b may be used to define a TIME_DOMAIN_BEAM_CONFIG command. The TIME_DOMAIN_BEAM_CONFIG command may refer to a command that sends a time-domain beam group uniquely identifying time-domain beam number vector and/or associated time-domain beamforming weights to the O-RU.

Moreover, the ST4CmdType field 0000 0010b may be used to define a TDD_CONFIG_PATTERN command. The TDD_CONFIG_PATTERN command may specify the symbol direction, for example, in the Uplink/Downlink (UL/DL) direction in a dynamic TDD configuration use case. To this end, for example, the TDD_CONFIG_PATTERN command may specify the guard symbols for DL to UL switching.

Furthermore, ST4CmdType field 0000 0011b may define a CONFIGURATION_SET_#N command. The CONFIGURATION_SET_#N command specifies the TRx control configuration/the antenna model to be applied to an O-RU.

For example, the CONFIGURATION_SET_#N command may specify the application of the transceiver (TRx) control process to reconfigure the antenna array comprising at least one antenna model to a radio unit (O-RU) based on the requested antenna array reconfiguration and antenna configuration capability information of the O-RU required to perform an antenna array reconfiguration.

According to another example, the CONFIGURATION_SET_#N command may specify the TRx control configuration/antenna model to be applied during an energy-saving model.

Moreover, ST4CmdType message fields such as, for example, 0000 0000b, 0000 0100b to 1111 111 lb are reserved for other commands relating to the implementation of the application of the TRx control process to reconfigure an antenna array.

In an example embodiment, the first Control Plane (C-Plane) message according to FIGS. 4 and 9A may comprise commands in fields such as 0000 0000b, 0000 0100b to 1111 111 Ib, etc. as set forth above.

Still referring to FIG. 10, in the case of using the CONFIGURATION_SET_#N command, a selected array configuration for an antenna model may be used to select the respective ports to be muted or shut down.

To this end, among other commands in the ST4 message fields as forth above, the CONFIGURATION_SET_#N command may comprise the scope (i.e., the command scope) of an ARRAY-COMMAND, a CARRIER-COMMAND, an O-RU-COMMAND, etc.

For example, the ARRAY-COMMAND may apply to endpoints associated with an antenna array associated with the endpoint receiving the ST4 message, wherein the endpoints associated with the antenna arrays having shared or co-located array elements (i.e., antenna elements) with the array associated with the endpoint receiving the ST4 message.

According to the ARRAY-COMMAND if the command type applies to both UL and DL then the ARRAY-COMMAND may apply to endpoints of both Receiver RX and Transmitter TX directions regardless of the direction of the endpoint receiving the ST4 message. Otherwise, the ARRAY-COMMAND may apply to endpoints in the same direction as the endpoint receiving the ST4 message.

The CARRIER-COMMAND may apply to all endpoints associated with the array carrier associated with the endpoint receiving the ST4 message.

The O-RU-COMMAND may apply to both UL and DL. In this case, the O-RU-COMMAND may apply to endpoints of both RX and TX directions regardless of the direction of the endpoint receiving the ST4 message. Otherwise, the command applies to endpoints in the same direction as the endpoint receiving the ST4 message.

In addition, when the O-RU-COMMAND may apply to multiple O-DUs sharing RF circuits in a single O-RU, the O-DUs may cooperate (communicate with each other) to ensure that the effect of the ST4 message command (i.e., CARRIER-COMMAND, ARRAY-COMMAND, etc.) is appropriate for each of the multiple O-DUs affected by the O-RU-COMMAND.

This has the advantage that the transceiver (TRx) control process (i.e., the selection of an efficient antenna array reconfiguration) according to FIGS. 4 and 9A is backward compatible with the standard protocols (i.e., ST4Cmd message format) and therefore facilitates an easy and standardized implementation thereof.

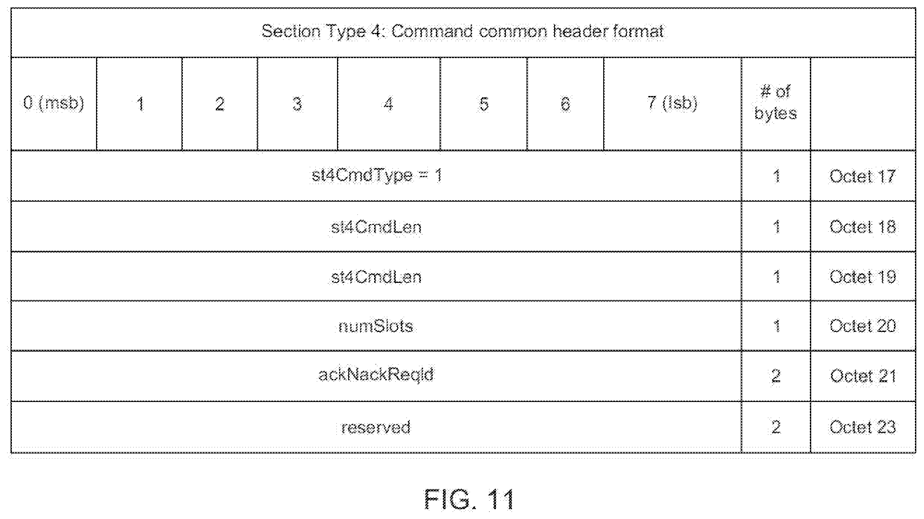

FIG. 11 illustrates command common header fields for applying an antenna array reconfiguration using an ST4 message according to an embodiment. Referring to FIG. 11, the Command Common Header Format of a Section Type 4 message is shown. The Command Common Header Format comprises 8-bit fields (i.e., octet fields).

The Command Common Header Format comprises various headers, each header comprising one or more header fields (i.e., header octets). The number of header fields occupied by the header is counted in a byte sequence (i.e., from # of bytes).

The position in the byte sequence (i.e., # of bytes) comprises certain header fields such as st4CmdType=1, as the first byte in the byte sequence and the 17^{th} octet in the Section Type 4 message, st4CmdLen (i.e., command length value) as the second byte in the byte sequence and the 18^{th} octet in the Section Type 4 message, another st4CmdLen as the third byte in the byte sequence and the 19^{th} octet in the Section Type 4 message, numSlots (i.e., number of slots) as the fourth byte in the byte sequence and the 20^{th} octet in the Section Type 4 message, ackNackReqId (i.e., Acknowledge (ACK)/Negative-Acknowledge (NACK) notification by O-RU to O-DU) as the fifth and sixth byte in the byte sequence and the 21^{st} and 22^{nd} octet in the Section Type 4 message, and reserved header fields as the 7th and 8th byte in the byte sequence and the 23rd and 24^{th} octet in the Section Type 4 message.

In an example embodiment, the ST4 common header parameter ‘numSlots’ may be used to let the TRx control configuration remain active for a longer duration.

For example, the “numSlots” parameter in ST4 Command Common Header Format can be used to indicate the number of slots for which the operation (e.g., ES mode, advance sleeping mode, etc.) to be executed (e.g., slot by slot or PRB (Physical Resource Block) by PRB).

To this end, the numSlots (number of slots) may specify the number of contiguous slots for which an ST4 command as set forth in FIG. 10 is applicable. As a result, the ST4 command configuration remains applicable for the numSlots as defined in numSlots. In case there is no change the value of this parameter numSlots may be set to zero.

Moreover, the parameter ackNackReqId (i.e., Acknowledge (ACK)/Negative-Acknowledge (NACK) notification) according to the third C-Plane message may define the TRx control configuration success/failure notification.

As a result, dynamic reconfiguration can be achieved where the O-RU can report RF channel configuration changes via Section Type and Section Extension messages. For example, slot-by-slot or PRB-by-PRB (Physical Resource Block) deactivation of O-RU elements such as RF receiver chains supports optimal muting functionality in different deactivation periods (i.e., from a very short slot level period or a longer time).

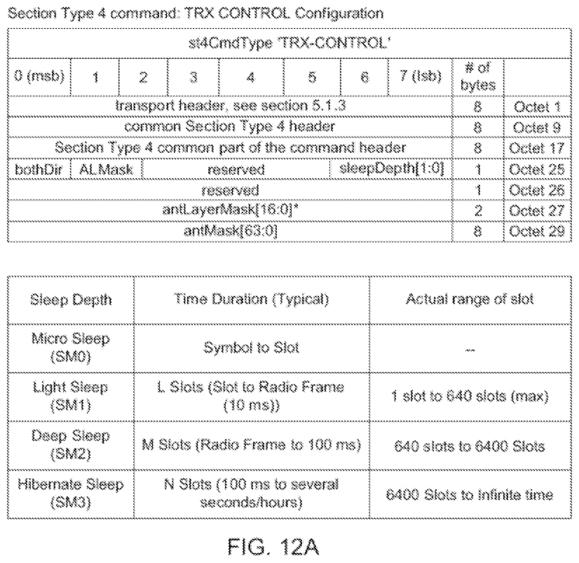

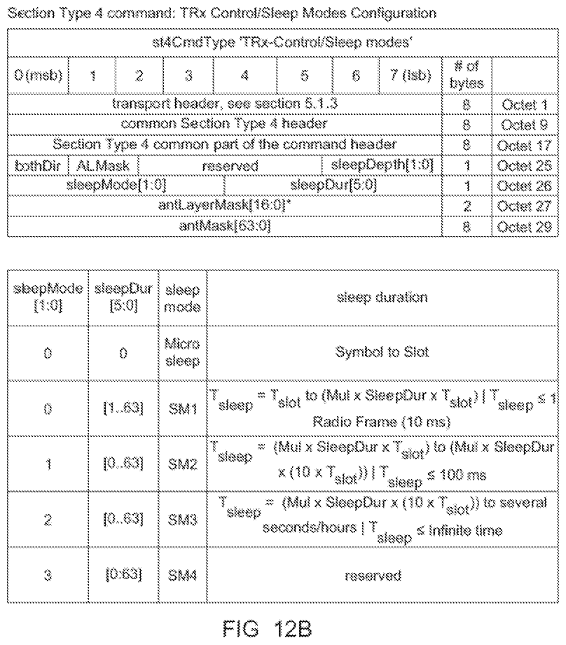

FIG. 12A illustrates an embodiment of sleep modes according to a Section Type 4 command type (ST4CmdType) TRX CONTROL. Referring to FIG. 12A, sleep modes have different sleep depths.

Referring to FIG. 12A, in a TRx control process via at least one Section Type 4 command type (ST4CmdType) field of an ST4 message in the C-Plane only one TRX CONTROL command may be sent to an O-RU per slot per tx-array or rx-array.

TRX CONTROL command type is in line with the Section Type 4 command type (ST4CmdType) and has the configuration as depicted in FIG. 11, wherein the Command Common Header Format comprises 8-bit fields (i.e., octet fields). The Command Common Header Format comprises various headers, each header comprising one or more header fields (i.e., header octets).

According to the TRX CONTROL command type configuration, a first header field is occupied by a transport header. The transport header refers to an 8-byte sequence of a first Octet (i.e., from # of bytes is 8 from Octet 1 to Octet 8).

A second header field is occupied by a common Section Type 4 header. The common Section Type 4 header refers to an 8-byte sequence of a 9th Octet (i.e., from # of bytes is 8 from Octet 9 to Octet 16).

A third header field is occupied by a Section Type 4 common part of the command header. The Section Type 4 common part of the command header refers to an 8-byte sequence of a 17th Octet (i.e., from # of bytes is 8 from Octet 17 to Octet 24).

A fourth header field is occupied by a multiple command Section Type 4 header that refers to a one-byte sequence of a 25th Octet (i.e., from # of bytes is 1 of an Octet 25). The multiple commands Section Type 4 header comprises a direction identifier bothDir at the most significant msb 0-bit position, an Antenna Layer Mask identifier ALMask at a 1-bit position, wherein the Antenna Layer Mask parameter antLayerMask is present only if ALMask has the value 1 and otherwise the 1-bit position field is reserved. Moreover, the 2-bit position to the 5-bit position of the multiple command Section Type 4 header is reserved. The 6-bit position and the least significant bit, the 7-bit position, refer to the sleep depth of advanced sleep modes.

According to an example embodiment, the sleep depth according to the 6-bit position and the least significant bit, may be defined by 4 categories. The first category has a value of 0 that refers to no indicated sleep depth, wherein O-DU may issue another TRX-COMMAND in any future slot. The second category has a value of 1 that refers to a “light” sleep, wherein 0-DU may activate antenna elements/layers only after L slots after the current slot. The third category has a value of 2 that refers to “medium” sleep, wherein O-DU may activate antenna elements/layers only after M slots after the current slot. A fourth category has a value of 3 that refers to “narcoleptic” sleep, O-DU may activate antenna elements/layers only after N slots after the current slot.

A fifth header field may be reserved and a one-byte sequence of a 26th Octet (i.e., from # of bytes is 1 of an Octet 26).

Alternatively, the fifth header field is occupied by a sleep mode command header. The sleep mode command header includes a first part occupying the bit sequence between the most significant bit, 0-bit position, and the 3-bit position (or the 4-bit position) and a second part occupying a bit sequence between the 4-bit position (or the 5-bit position) and the least significant bit, 7-bit position. The first part refers to the sleep mode and the second part refers to the sleep duration. The sleep mode command header refers to a one-byte sequence of a 26th Octet (i.e., from # of bytes is 1 of an Octet 26).

A sixth header field is occupied by the Antenna Layer Mask antLayerMask command header. The antLayerMask header refers to a 2-byte (16-bit) sequence of a 27th Octet (i.e., from # of bytes are 2 from Octet 27 to Octet 28).

A seventh header field is occupied by the Antenna Mask antMask command header. The antMask header refers to an 8-byte (64-bit) sequence of a 29th Octet (i.e., from # of bytes are 8 from Octet 29 onwards).

According to an example embodiment, the TRx control process to reconfigure the antenna array may include TRx control configurations that are identified by a respective unique configuration identity or name. The antenna array model of said TRx control configuration includes at least one antenna mask (antMask), wherein the antenna mask bits combination may be limited only to the supported TRx control configurations, wherein the antenna mask bits identify a ‘0’ for antenna elements to be turned off and ‘1’ for active elements of the antenna array. Moreover, TRx control configurations include in addition to the mask bits for at least one antenna mask (antMask), antenna layer mask bits for creating at least one antenna layer mask (antLayerMask).

According to an example embodiment, the supported TRx control configurations may comprise a transition time (i.e., different from a wake-up time of the ASMs) that defines a minimum or guaranteed time required to switch from baseline configuration to specific configuration (i.e., switch a baseline 64TRx antenna array to another antenna mask configuration such as, for example, a 32TRx_antenna array model). The transition time associated with each configuration change for the supported TRx control configurations and as a function of sub-carrier spacing may be, for example, for 15 KHz, one slot is 1 millisecond, for 30 KHz, one slot is 0.5 millisecond or 500 microseconds, etc.

According to an example embodiment, the TRx control process may include control to turn on/off entire RF Transceiver chains and/or Radio Frequency Front End (RFFE) of Radio Frequency (RF) processing unit pertaining to some of the RF channels/antenna elements.

Moreover, according to another example embodiment, the TRx control process may include control to turn on/off Components, Circuits, IPs, Cores, Computing engines of the digital baseband and O-RAN Fronthaul processing units (i.e., physical components of the O-RU).

According to embodiments of the Advanced Sleep Modes (ASM) having short duration (C-Plane based) sleep modes and sleep modes having long duration (M-Plane based) sleep modes the wake-up latency (i.e., the wake-up time or the go-to-sleep time) for said ASM and the wake-up latency of the TRx control may be different and not interfere with (e.g., hinder) each other.

Referring to FIG. 12A, according to the first embodiment, a first type of SM may enable a micro-sleep mode (i.e., SM 0) on a symbol to slot-based time duration (i.e., temporary deactivation of the O-RU components within a symbol to slot-based time duration).

According to SM 0 (i.e., the micro-sleep mode), in case the E2 node (e.g., a gNB) does not need to operate TX/RX information within the next few orthogonal frequency division multiplexing (OFDM) symbols (i.e., truncated OFDM (TOFDM)-Symbol<T≤Slot [ms]), for example, Radio Frequency (RF) transceivers may be turned off for this period Truncated OFDM (TOFDM)-Symbol<T≤Slot [ms] up to one millisecond (ms).

To this end, the sleep duration for SM 0 (i.e., the micro-sleep mode) would be based on O-RU capability to support the lowest granularity of sleeping intervals (i.e., the finest subdivision of deactivation states on a symbol to slot-based time duration). The lowest granularity of sleeping intervals demands the highest level of O-RU capabilities from the O-RU components to support the micro-sleep mode) as the turn-off period may be an OFDM symbol duration of up to one millisecond. The wake-up latency of SM 0 to turn on the Radio Frequency (RF) transceivers is a few microseconds and implies no active Radio Frontend (RF).

The SM 0 (i.e., the micro-sleep mode) has the advantage that in accordance with the O-RU capability and O-DU capability to detect and respond to subtle changes in traffic patterns, the O-RU capabilities to temporarily deactivate the O-RU components within symbol to slot-based time duration enable the O-DU to take more precise energy-saving measures, rather than relying on broad, blanket policies for energy-saving.

According to a second embodiment, another type of ASM may enable a light sleep mode (i.e., SM 1) on an L-Slot(s) based time duration (one slot to 10 ms) (i.e., temporary deactivation of the O-RU components within an L-Slots based time duration).

According to the light sleep mode (i.e., SM 1), in case the E2 node (e.g., a gNB) does not need to operate TX/RX information within the next L Slots (e.g., Slot≤T≤10 ims), for example, Radio Frequency (RF) transceivers and additional hardware components (i.e., other physical O-RU components) can be turned off for the prescribed period of, for example, between 5 ms and 10 ms. According to an example embodiment, the actual range of slots to implement SM 1 may be between one slot and 640 slots (e.g., a maximum of 640 slots). The wake-up latency of SM 1 to turn on the Radio Frequency (RF) transceivers is a few microseconds to several milliseconds and implies no active Radio Frontend (RF).

To this end, the sleep duration for SM 1 (i.e., the light sleep mode) is based on an O-RU capability level (i.e., O-RU capability to comply with a temporary deactivation of the O-RU's (physical) components) that to support the sleep duration (deactivation interval) between, for example, 5 ms to 10 ms.

As a result, in the case of SM 1 (i.e., the light sleep mode), the power consumption of the O-RU components is typically lower compared to that of the micro-sleep mode (i.e., SM 0).

Moreover, according to an example embodiment, the light sleep mode may be implemented via transmission blanking when there is neither a Synchronization Signal Block (SSB) in the downlink (DL) nor in the Physical Random-Access Channel (PRACH), or there are no other uplink (UL) signals to be transmitted/received.

According to a third embodiment, another type of ASM may enable a deep sleep mode (i.e., SM 2) on an M-Slot(s) based duration time (Radio Frame to 100 ms) (i.e., temporary deactivation of the O-RU components within an M-Slot(s) based time duration).

According to the deep sleep mode (i.e., SM 2), in case the E2 node (e.g., a gNB) does not need to operate TX/RX information within the next M Slots (e.g., 10 ms≤T≤100 ms), for example, additional hardware components (i.e., other physical O-RU components) can be turned off for the prescribed period as set forth above. However, in accordance with the deep sleep mode (i.e., SM 2) some hardware components of the O-RU such as timing circuitry must be kept on standby or maintained active to allow the O-RU a fast transition to an active state (i.e., to instantly rollback). The power consumption of the deep sleep mode (i.e., SM 2) is lower compared to that of light sleep mode (i.e., SM 1).

The sleep duration for deep sleep mode (i.e., SM 2) may be based on the O-RU's capability to support sleep duration (i.e., deactivation duration) between a Radio Frame to 100 ms.

According to an example embodiment, the actual range of slots to implement SM 2 may be between 640 slots and 6400 slots. The wake-up latency of SM 2 to turn off additional hardware components (i.e., other physical O-RU components) is 10 to 20 milliseconds and implies no active Radio Frontend (RF).

According to the relatively long deactivation duration, the deep sleep mode (i.e., SM 2) requires coordination with other neighboring cells since user experience would be affected if a cell is turned off, for example, more than 50 ms, for the deactivation period in accordance with SM 2. Thus, the O-DU may need to schedule and send an O-RU implementation instruction command to the O-RUs.

According to a fourth embodiment, another type of ASM may enable a hibernate sleep mode (i.e., SM 3) on an N-Slot(s) based duration time (e.g., 100 ms to several seconds) (i.e., temporary deactivation of the O-RU components within an N-Slot(s) based time duration).

According to the hibernate sleep mode (i.e., SM 3), in case the E2 node (e.g., a gNB) does not need to operate TX/RX information within the next N Slots (e.g., 100 ms to several seconds), for example, most of the hardware components (i.e., almost all physical O-RU components) may be turned off for the prescribed period as set forth above. However, in accordance with the hibernate sleep mode (i.e., SM 3) some hardware components of the O-RU such as timing circuitry must be kept on standby or maintained active to allow the O-RU a fast transition to an active state (i.e., to instantly rollback). The power consumption of the hibernate sleep mode (i.e., SM 3) is lower compared to that of deep sleep mode (i.e., SM 2), wherein sleep durations greater than 1000 ms may not be precluded. According to an example embodiment, the actual range of slots to implement SM 1 may be between 6400 slots and an infinite number of slots (i.e., time). The wake-up latency of SM 3 to turn most of the hardware components (i.e., almost all physical O-RU components) is at least 100 milliseconds and implies no active Radio Frontend (RF).

The sleep duration for hibernate sleep mode (i.e., SM 3) may be based on the O-RU's capability to support a sleep duration (i.e., deactivation duration) between 100 ms to several seconds. According to the relatively long deactivation duration, the hibernate sleep mode (i.e., SM 3) requires coordination with other neighboring cells since user experience would be affected if a cell is turned off for the deactivation period in accordance with SM 3. Thus, the O-DU may need to schedule and send an O-RU implementation instruction command to the O-RUs.

FIG. 12B illustrates another embodiment of sleep modes according to a Section Type 4 command type (ST4CmdType) TRX CONTROL. Referring to FIG. 12B, sleep modes have different sleep duration according to the fifth header field that includes a first part occupying the bit sequence between the most significant bit, 0-bit position, and the 3-bit position (or the 4-bit position) and a second part occupying a bit sequence between the 4-bit position (or the 5-bit position) and the least significant bit, 7-bit position, wherein the first part refers to the sleep mode (sleepMode [1:0]) and the second part refers to the sleep duration (sleepDur [5:0]). The sleep mode command header refers to a one-byte sequence of a 26th Octet (i.e., from # of bytes is 1 of an Octet 26). According to another embodiment, the sleep mode sleepMode and the sleep depth sleepDepth may occupy 3 bits each. According to yet another embodiment, the sleep duration sleepDur may occupy 8 bits, for example, the one Octet may be defined in ST4 command to support various sleep durations).

According to the example embodiment, the micro sleep according to SM 0 refers to sleepMode value 0 and the sleepDur value 0.

The light sleep mode according to SM 1 refers to sleepMode value 0 and the sleepDur value between 0 and 63, wherein the sleep duration time is between is between the time duration for one slot and the product of a predetermined factor Mul, the sleep duration value sleepDur and the time duration for one slot, wherein the time of a Radio Frame (10 ms) is the upper limit of SM 0 (i.e., Tₛₗₑₑₚ=Tₛₗₒₜ to (Mul×SleepDur×Tₛₗₒₜ) Tₛₗₑₑₚ≤1 Radio Frame (10 ms)).

The deep sleep mode according to SM 2 refers to sleepMode value 1 and the sleepDur value between 0 and 63, wherein the sleep duration time is between the product of a predetermined factor Mul, the sleep duration value sleepDur and the time duration for one slot and the product of the predetermined factor Mul, the sleep duration value sleepDur and the time duration of at least 10 slots, wherein the time duration of 100 ms is the upper limit of SM 2 (i.e., Tₛₗₑₑₚ=(Mul×SleepDur×Tₛₗₒₜ) to (Mul×SleepDur×(10×Tₛₗₒₜ))|Tₛₗₑₑₚ≤100 ms).

The hibernate sleep mode according to SM 3 refers to sleepMode value 2 and the sleepDur value between 0 and 63, wherein the sleep duration time is between the product of the predetermined factor Mul, the sleep duration value sleepDur and the time duration of at least 10 slots and the time duration for several seconds to hours, wherein there no upper limit to SM 3 (i.e., Tₛₗₑₑₚ=(Mul×SleepDur×Tₛₗₒₜ) to seconds to hours)) Tₛₗₑₑₚ is an infinite time).

According to the above sleep mode duration, the number of slots in a radio frame depends on the Sub-Carrier Spacing SCS used, for example, for 15 KHz, one slot is 1 millisecond, for 30 KHz, one slot is 0.5 millisecond or 500 microseconds, etc. Thus, the max number of slots varies within defined sleep modes, respectively, Moreover, the predetermined factor Mul (multiplier) and the parameter sleepDur are parameters employed to provide flexibility in defining the number of slots in a specific sleep mode (e.g., in SM1 the of slots can be 2 to 640 slots).

Moreover, sleepMode value 3 and the sleepDur value between 0 and 63 refer to reserved sleep modes which may relate to further granulation of the hibernate sleep mode to a light-hibernate-sleep and a deep-hibernate-sleep.

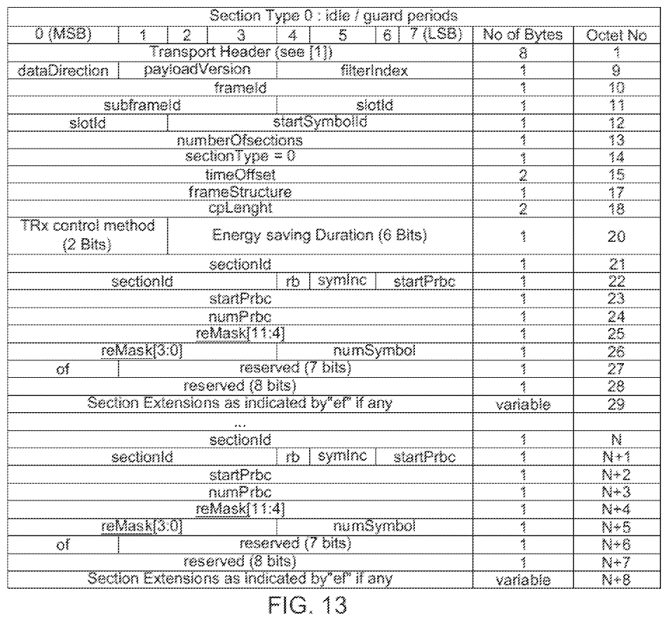

FIG. 13 illustrates a parameter and command common header fields for applying an antenna array reconfiguration using Section Type (ST) 0 messages according to an embodiment.

Referring to FIG. 13, an ST0—Section Extension 10 (SE10) message can be used to group multiple ports and merge them to a representative port configured by M-Plane. By grouping, the selected elements may be masked/muted according to the TRx control configuration process.

To this end, for grouping desired ports by SE 10 message parameter “numPortc” may be used. In particular, at least one of the following beamGroupType fields may be used to indicate the type of beam grouping.

For example, beamGroupType field 00b (common beam) refers to a beamID in the section header that is used as a common beamID for all “numPortc” ports which are grouped by M-Plane, wherein this type is not used for Section Type 5, and extLen=0x01.

Moreover, beamGroupType field 01b (beam matrix indication) refers to consecutive “numPortc” beamIDs subsequent to the beamID in the section header that apply to the “numPortc” ports, wherein this type is not used for Section Type 5, and extLen=0x01.

Furthermore, beamGroupType field 10b (beam vector listing) refers to beamIDs listed in the Section Extension that apply to the “numPortc” ports. This Section Extension may include ‘numPortc’ beamIDs or ueIDs (user equipment IDs).

In addition, beamGroupType field 11b refers to reserved fields that may be used for indicating the type of beam grouping for selected elements to be masked/muted according to the TRx control configuration process.

In another example embodiment, an ST0—Section Extension 7 (SE7) message may be used to activate, by the O-DU, a required antenna array model by masking, blanking, muting, etc. of antenna elements within an existing specification for ST0—Section Extension 7 (SE7) message in the C-Plane. For example, the SE 7 message may be used for an extended Antenna Carrier (eAXC) mask, wherein the mask (i.e., the masking pattern) is a part of the eAXC identifier (ID) designated by ST0 messages.

In another example, the SE7 message may be used to modify the number of spatial streams while activating the respective antenna model (i.e., the TRx elements in the antenna array).

To this end, for all ST0 messages, the scheduling (i.e., the idle or guard periods) together with the beamforming commands according to the ST0 message frame format may be used for implementing the TRx control configuration processes as set forth above.

The ST0 message frame format comprises Section Type 0 common header fields (i.e., 8-bit fields) in a byte sequence (i.e., no. of bytes). The common header fields are lined up in octets (i.e., number of octets) and are used for indicating the idle or guard periods from the O-DU to the O-RU. In particular, the ST0 common header fields include a dataDirection (data direction (eNB, TxRx)) field of 1 bit, a payloadVersion (payload version) field of 3 bits (value=1 shall be set (1^{st} protocol version for payload and time reference format), a filterIndex (filter index) field of 4 bits, a frameId (frame identifier) field of 8 bits, a subframeId (subframe identifier) field of 4 bits, a slotID (slot identifier) field of 6 bits, a startSymbolId (start symbol id) field of 6 bits, a numberOfsections (number of sections) field of 8 bits, a sectionType (Section Type) field of 8 bits (value is set to zero (i.e., ST0)), a timeOffset (time offset) field of 16 bits (2 octets), a frameStructure (frame structure) field of 8 bits, a cpLength (cyclic prefix length) field of 16 bits and a reserved (reserved for future use) field 8 bits.

According to an example embodiment, the reserved field in the Common Header Fields may comprise a mTRx control method of 2 bits and an Energy-saving Duration (i.e., a deactivation period for deactivating physical elements (e.g., TRx elements or chains of an antenna array) or logistical elements (e.g., control function services) of the O-RU) of 6 bits.

Moreover, The ST0 message frame format comprises section fields. The section fields comprise a sectionId (section identifier) field of 12 bits, a rb (resource block indicator) field of 1 bit, a symInc (symbol number increment command) field of 1 bit, a startPrbc (starting PRB of data section description) field of 10 bits.

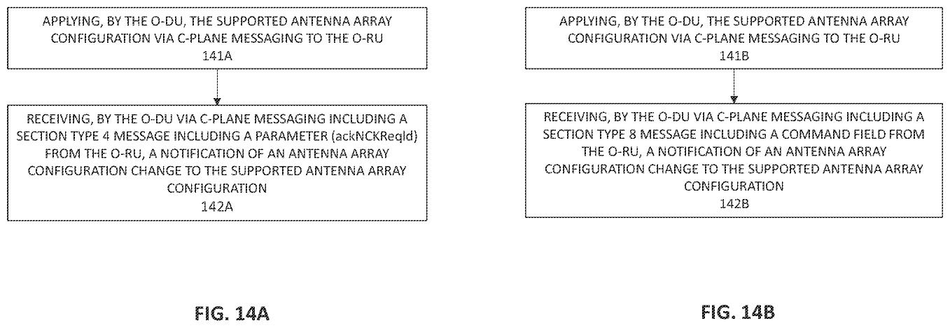

FIG. 14A illustrates a method for notifying a configuration change via a ST4CmdType of ST4 message in the C-Plane according to an embodiment;

Referring to FIG. 14A, in step 141A, the O-DU applies the supported antenna array configuration via C-Plane messaging to the O-RU.

In step 142A, the O-DU receives a response to an antenna array configuration change to the supported antenna array configuration from the O-RU via C-Plane messaging including a Section Type (ST) 4 message including a parameter (ackNCKReqld).

FIG. 14B illustrates a method for notifying a configuration change via a reserved field in an ST8 message in the C-Plane according to an embodiment.

Referring to FIG. 14B, in step 141B, the O-DU applies the supported antenna array configuration via C-Plane messaging to the O-RU.

In step 142B, while notifying a configuration change, O-DU receives a response to an antenna array configuration change to the supported antenna array configuration from the O-RU via C-Plane messaging including a Section Type 8 message including a command field.

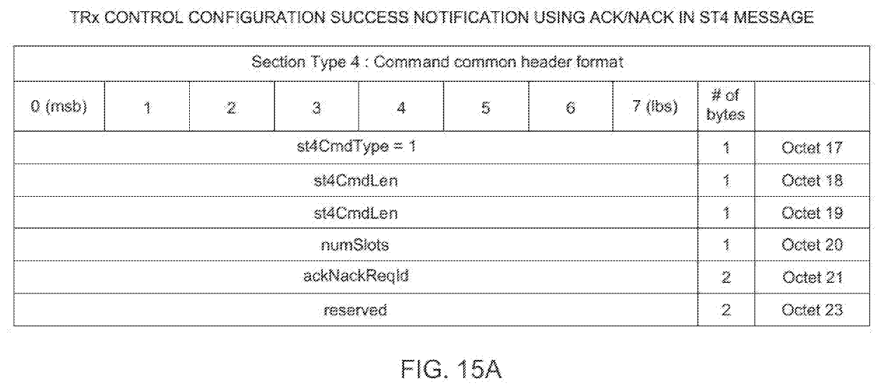

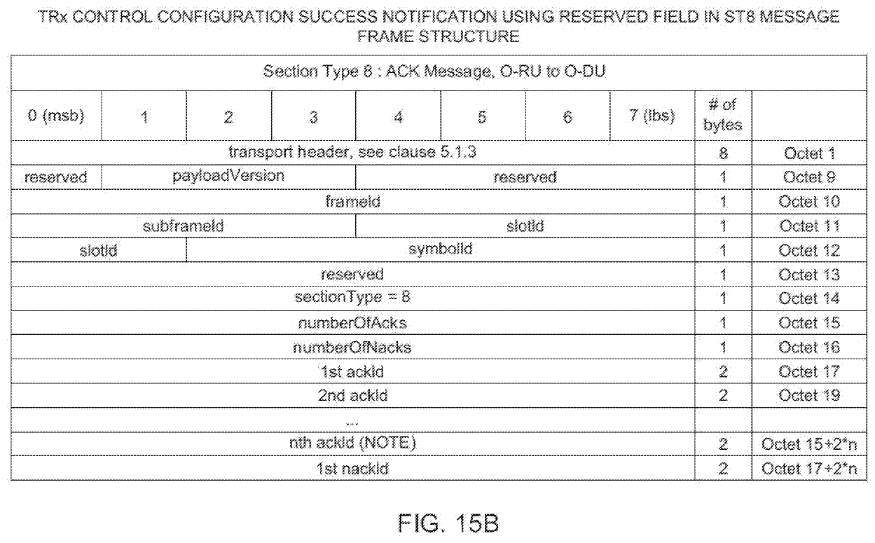

FIG. 15A illustrates a command common header field for a TRx control configuration success notification using ACK/NACK in an ST4 message according to an embodiment. Referring to FIG. 15A, like FIG. 12, the command common header field ackNackReqId (i.e., Acknowledge (ACK)/Negative-Acknowledge (NACK) notification) according to the third C-Plane message may define the TRx control configuration success/failure response via the C-Plane according to FIG. 2 or FIG. 3 (i.e., the response from the O-RU to O-DU after changing the antenna array configuration according to step 205 or 304, respectively).

FIG. 15B illustrates a command common header field for a TRx control configuration success notification using a reserved field in an ST8 message. Referring to FIG. 15B, the command common header field according to the 13^{th} octet marked as reserved and therefore may be a third C-Plane message for a TRx control configuration success/failure response via the C-Plane according to FIG. 2 or FIG. 3 (i.e., the response from the O-RU to O-DU after changing the antenna array configuration according to step 205 or 304, respectively).

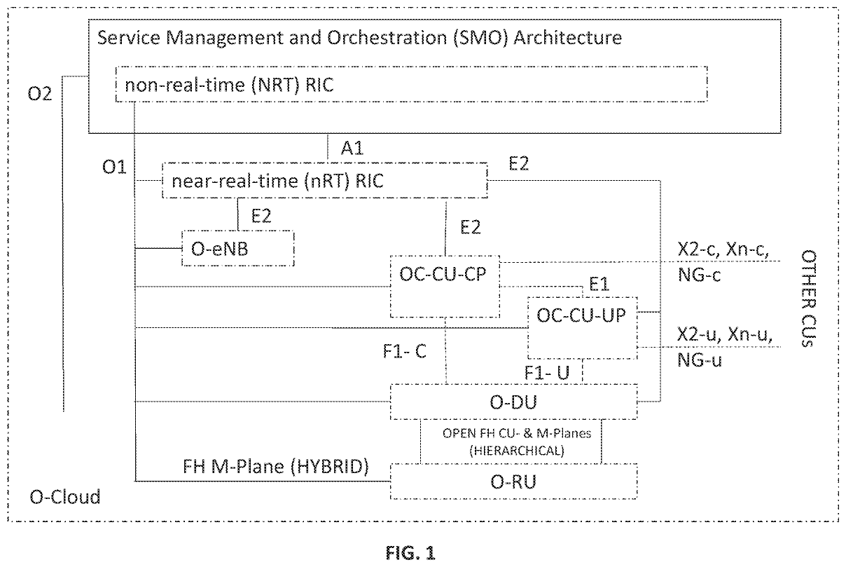

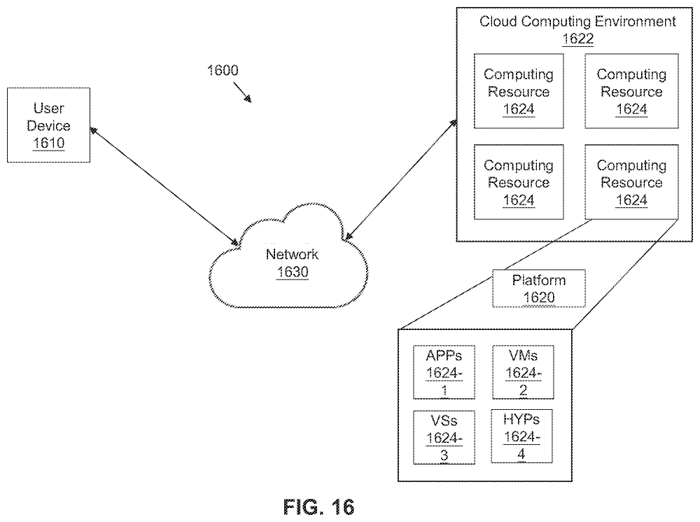

FIG. 16 is a diagram of an example environment 1600 in which systems and/or methods, described herein, may be implemented. As shown in FIG. 16, environment 1600 may include a user device 1610, a platform 1620, and a network 1630. Devices of environment 1600 may interconnect via wired connections, wireless connections, or a combination of wired and wireless connections. In embodiments, any of the functions and operations described with reference to FIG. 1 above may be performed by any combination of elements illustrated in FIG. 16.

User device 1610 includes one or more devices capable of receiving, generating, storing, processing, and/or providing information associated with platform 1620. For example, user device 1610 may include a computing device (e.g., a desktop computer, a laptop computer, a tablet computer, a handheld computer, a smart speaker, a server, etc.), a mobile phone (e.g., a smartphone, a radiotelephone, etc.), a wearable device (e.g., a pair of smart glasses or a smart watch), or a similar device. In some implementations, user device 1610 may receive information from and/or transmit information to platform 1620.

Platform 1620 includes one or more devices capable of receiving, generating, storing, processing, and/or providing information. In some implementations, platform 1620 may include a cloud server or a group of cloud servers. In some implementations, platform 1620 may be designed to be modular such that certain software components may be swapped in or out depending on a particular need. As such, platform 1620 may be easily and/or quickly reconfigured for different uses.

In some implementations, as shown, platform 1620 may be hosted in cloud computing environment 1622. Notably, while implementations described herein describe platform 1620 as being hosted in cloud computing environment 1622, in some implementations, platform 1620 may not be cloud-based (i.e., may be implemented outside of a cloud computing environment) or may be partially cloud-based.

Cloud computing environment 1622 includes an environment that hosts platform 1620. Cloud computing environment 1622 may provide computation, software, data access, storage, etc., services that do not require end-user (e.g., user device 1610) knowledge of a physical location and configuration of system(s) and/or device(s) that hosts platform 1620. As shown, cloud computing environment 1622 may include a group of computing resources 1624 (referred to collectively as “computing resources 1624” and individually as “computing resource 1624”).

Computing resource 1624 includes one or more personal computers, a cluster of computing devices, workstation computers, server devices, or other types of computation and/or communication devices. In some implementations, computing resource 1624 may host platform 1620. The cloud resources may include compute instances executing in computing resource 1624, storage devices provided in computing resource 1624, data transfer devices provided by computing resource 1624, etc. In some implementations, computing resource 1624 may communicate with other computing resources 1624 via wired connections, wireless connections, or a combination of wired and wireless connections.

As further shown in FIG. 16, computing resource 1624 includes a group of cloud resources, such as one or more applications (“APPs”) 1624-1, one or more virtual machines (“VMs”) 1624-2, virtualized storage (“VSs”) 1624-3, one or more hypervisors (“HYPs”) 1624-4, or the like.

Application 1624-1 includes one or more software applications that may be provided to or accessed by user device 1610. Application 1624-1 may eliminate the need to install and execute the software applications on user device 1610. For example, application 1624-1 may include software associated with platform 1620 and/or any other software capable of being provided via cloud computing environment 1622. In some implementations, one application 1624-1 may send/receive information to/from one or more other applications 1624-1, via virtual machine 1624-2.

Virtual machine 1624-2 includes a software implementation of a machine (e.g., a computer) that executes programs like a physical machine. Virtual machine 1624-2 may be either a system virtual machine or a process virtual machine, depending upon use and degree of correspondence to any real machine by virtual machine 1624-2. A system virtual machine may provide a complete system platform that supports the execution of a complete operating system (“OS”). A process virtual machine may execute a single program and may support a single process. In some implementations, virtual machine 1624-2 may execute on behalf of a user (e.g., user device 1610), and may manage infrastructure of cloud computing environment 1622, such as data management, synchronization, or long-duration data transfers.

Virtualized storage 1624-3 includes one or more storage systems and/or one or more devices that use virtualization techniques within the storage systems or devices of computing resource 1624. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 1624-4 may provide hardware virtualization techniques that allow multiple operating systems (e.g., “guest operating systems”) to execute concurrently on a host computer, such as computing resource 1624. Hypervisor 1624-4 may present a virtual operating platform to the guest operating systems and may manage the execution of the guest operating systems. Multiple instances of a variety of operating systems may share virtualized hardware resources.

Network 1630 includes one or more wired and/or wireless networks. For example, network 1630 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 16 are provided as an example. In practice, there may be additional devices and/or networks, fewer devices and/or networks, different devices and/or networks, or differently arranged devices and/or networks than those shown in FIG. 16. Furthermore, two or more devices shown in FIG. 16 may be implemented within a single device or a single device shown in FIG. 16 may be implemented as multiple, distributed devices. Additionally, or alternatively, a set of devices (e.g., one or more devices) of environment 1600 may perform one or more functions described as being performed by another set of devices of environment 1600.

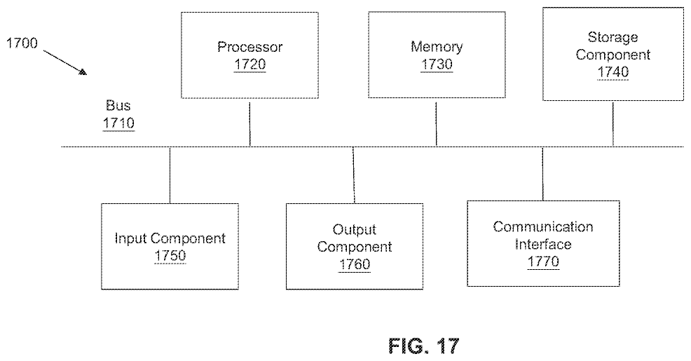

FIG. 17 is a diagram of example components of device 1700. Device 1700 may correspond to user device 1610 and/or platform 1620. As shown in FIG. 17, device 1700 may include a bus 1710, a processor 1720, a memory 1730, a storage component 1740, an input component 1750, an output component 1760, and a communication interface 1770.

Bus 1710 includes a component that permits communication among the components of device 1700. Processor 1720 may be implemented in hardware, firmware, or a combination of hardware and software. Processor 1720 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 1720 includes one or more processors capable of being programmed to perform a function. Memory 1730 includes a random-access memory (RAM), a read-only memory (ROM), and/or another type of dynamic or static storage device (e.g., a flash memory, a magnetic memory, and/or an optical memory) that stores information and/or instructions for use by processor 1720.

Storage component 1740 stores information and/or software related to the operation and use of device 1700. For example, a storage component 1740 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive. Input component 1750 includes a component that permits device 1700 to receive information, such as via user input (e.g., a touch screen display, a keyboard, a keypad, a mouse, a button, a switch, and/or a microphone). Additionally, or alternatively, input component 1750 may include a sensor for sensing information (e.g., a global positioning system (GPS) component, an accelerometer, a gyroscope, and/or an actuator). Output component 1760 includes a component that provides output information from device 1700 (e.g., a display, a speaker, and/or one or more light-emitting diodes (LEDs)).

Communication interface 1770 includes a transceiver-like component (e.g., a transceiver and/or a separate receiver and transmitter) that enables device 1700 to communicate with other devices, such as via a wired connection, a wireless connection, or a combination of wired and wireless connections. Communication interface 1770 may permit device 1700 to receive information from another device and/or provide information to another device. For example, communication interface 1770 may include an Ethernet interface, an optical interface, a coaxial interface, an infrared interface, a radio frequency (RF) interface, a universal serial bus (USB) interface, a Wi-Fi interface, a cellular network interface, or the like.

Device 1700 may perform one or more processes described herein. Device 1700 may perform these processes in response to processor 1720 executing software instructions stored by a non-transitory computer-readable medium, such as memory 1730 and/or storage component 1740. A computer-readable medium is defined herein as a non-transitory memory device. A memory device includes memory space within a single physical storage device or memory space spread across multiple physical storage devices.

Software instructions may be read into memory 1730 and/or storage component 1740 from another computer-readable medium or from another device via communication interface 1770. When executed, software instructions stored in memory 1730 and/or storage component 1740 may cause processor 1720 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components as shown in FIG. 17 are provided as an example. In practice, device 1700 may include additional components, fewer components, different components, or differently arranged components than those shown in FIG. 17. Additionally, or alternatively, a set of components (e.g., one or more components) of device 1700 may perform one or more functions described as being performed by another set of components of device 1700.

In embodiments, any one of the operations or processes of FIGS. 2 to 9 may be implemented by or using any one of the elements illustrated in FIGS. 1, 16 and 17. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description but is not intended to be exhaustive or to limit the implementations to the precise form disclosed. Modifications and variations are possible in light of the above disclosure or may be acquired from practice of the implementations.

Some embodiments may relate to a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a microservice(s), module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that apparatuses and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it being understood that software and hardware may be designed to implement the systems and/or methods based on the description herein.

Various further respective aspects and features of embodiments of the present disclosure may be defined by the following items:
Item [1] An apparatus includes: a distributed unit (O-DU) configured to: receive configuration capability information from a radio unit (O-RU) via management plane (M-Plane) messaging; receive a request to reconfigure an antenna array from a higher-layer network function; based on the configuration capability information from the O-RU and based on the request to reconfigure the antenna array from the higher-layer network function, determine an antenna array configuration supported by the O-RU; and apply the supported antenna array configuration via C-Plane messaging or M-Plane messaging to the O-RU.
Item [2] The apparatus according to Item [1], wherein the O-DU may be further configured to: receive, via C-Plane messaging or M-Plane messaging from the O-RU, a response to an antenna array configuration change to the supported antenna array configuration.
Item [3] The apparatus according to Item [1], wherein the C-Plane messaging to the O-RU may include at least one of: a Section Type 0 message with at least one of a Section Extension (SE) 7 message, an SE 10 message, an SE 11 message, an SE 16 message, and an SE 19 message; and a Section Type 4 message with an SE8 message.
Item [4] The apparatus according to any of Items [1 to 3], wherein: the C-Plane messaging to the O-RU defines a selection of Transceiver (TRx) control parameters to reconfigure the antenna array to be applied to the O-RU; and the C-Plane messaging to the O-RU may include: a Section Type 4 message comprising an ST4 command type header for activating or deactivating at least one TRx control parameter, and a Section Type 0 message with at least one of an SE 10 message, an SE 11 message, an SE 16 message, and an SE 19 message.
Item [5] The apparatus according to any of Items [1 to 4], wherein: the C-Plane messaging to the O-RU defines a selection of sleep mode parameters to reconfigure the O-RU; and the C-Plane messaging to the O-RU may include: a Section Type 4 message comprising an ST4 command type header for activating or deactivating at least one sleep mode, and a Section Type 0 message with at least one of an SE 10 message, an SE 11 message, an SE 16 message, and an SE 19 message.
Item [6] The apparatus according to any of Items [1 to 5], wherein the C-Plane messaging from the O-RU may include at least one of: a Section Type 4 Message including a parameter (ackNCKReqld); and a Section Type 8 Message including a command field.
Item [7] An apparatus includes: a radio unit (O-RU) configured to: send, to a distributed unit (O-DU), configuration capability information of the O-RU via management plane (M-Plane) messaging; receive, from the O-DU, an antenna array configuration supported by the O-RU via control plane (C-Plane) messaging or management plane (M-Plane) messaging, wherein the supported antenna array configuration is based on the configuration capability information of the O-RU and a request to reconfigure the antenna array from a higher-layer network function; and based on the supported antenna array configuration for the O-RU, change the antenna array configuration of the O-RU.
Item [8] The apparatus according to Item [7], wherein the O-RU may be further configured to: send, to the O-DU, a response to the change in the antenna array configuration via C-Plane messaging or M-Plane messaging.
Item [9] The apparatus according to Item [7], wherein the M-Plane messaging may include at least one of a Yang model for capability reporting of TRx control parameters, a Yang model for capability reporting of sleep modes and associated parameters, and a Yang model for capability reporting of data layer control parameters.
Item [10] A method includes: receiving, by a distributed unit (O-DU) from a radio unit (O-RU), configuration capability information via management plane (M-Plane) messaging from the O-RU; receiving, by the O-DU from a higher-layer network function, a request to reconfigure an antenna array; based on the configuration capability information from the O-RU and based on the request to reconfigure the antenna array from the higher-layer network function, determining, by the O-DU, an antenna array configuration supported by the O-RU; and applying, by the O-DU, the supported antenna array configuration via C-Plane messaging or M-Plane messaging to the O-RU.
Item [11] The method according to Item [10], wherein the method is may further include: receiving, by the O-DU via C-Plane messaging or M-Plane messaging from the O-RU, a response to an antenna array configuration change to the supported antenna array configuration.
Item [12] The method according to Item [10], wherein the C-Plane messaging to the O-RU may include at least one of: a Section Type 0 message with at least one of a Section Extension (SE) 7 message, an SE 10 message, an SE 11 message, an SE 16 message, and an SE 19 message; and a Section Type 4 message with an SE 8 message.
Item [13] The method according to any of Items [10 to 12], wherein: the C-Plane messaging to the O-RU defines a selection of Transceiver (TRx) control parameters to reconfigure the antenna array to be applied to the O-RU; and the C-Plane messaging to the O-RU may include: a Section Type 4 message comprising an ST4 command type header for activating or deactivating at least one TRx control parameter, and a Section Type 0 message with at least one of an SE 10 message, an SE 11 message, an SE 16 message, and an SE 19 message.
Item [14] The method according to any of Items [10 to 13], wherein: the C-Plane messaging to the O-RU defines a selection of sleep mode parameters to reconfigure the O-RU; and the C-Plane messaging to the O-RU may include: a Section Type 4 message comprising an ST4 command type header for activating or deactivating at least one sleep mode, and a Section Type 0 message with at least one of an SE 10 message, an SE 11 message, an SE 16 message, and an SE 19 message.
Item [15] The method according to any of Items [10 to 14], wherein the C-Plane messaging from the O-RU may include at least one of: a Section Type 4 Message including a parameter (ackNCKReqld); and a Section Type 8 Message including a command field.
Item [16] A method includes: sending, by a radio unit (O-RU) to a distributed unit (O-DU), configuration capability information via management plane (M-Plane) messaging; receiving, by the O-RU from the O-DU, an antenna array configuration supported by the O-RU via control plane (C-Plane) messaging or management plane (M-Plane) messaging, wherein the supported antenna array configuration is based on the configuration capability information of the O-RU and a request to reconfigure the antenna array from a higher-layer network function; and based on the supported antenna array configuration for the O-RU, changing, by the O-RU, the antenna array configuration of the O-RU.
Item [17] The method according to Item [16], wherein the method may further include: sending, by the O-RU to the O-DU, a response to an antenna array configuration change to the supported antenna array configuration via C-Plane messaging or M-Plane messaging.
Item [18] The method according to Item [16], wherein the M-Plane messaging may include at least one of a Yang model for capability reporting of TRx control parameters, a Yang model for capability reporting of sleep modes and associated parameters, and a Yang model for capability reporting of data layer control parameters.

What is claimed is:

1. An apparatus comprising:
a distributed unit (O-DU) configured to:
receive configuration capability information from a radio unit (O-RU) via management plane (M-Plane) messaging;
receive a request to reconfigure an antenna array from a higher-layer network function;
based on the configuration capability information from the O-RU and based on the request to reconfigure the antenna array from the higher-layer network function, determine an antenna array configuration supported by the O-RU; and
apply the supported antenna array configuration via C-Plane messaging or M-Plane messaging to the O-RU.

2. The apparatus as claimed in claim 1, wherein the O-DU is further configured to:
receive, via C-Plane messaging or M-Plane messaging from the O-RU, a response to an antenna array configuration change to the supported antenna array configuration.

3. The apparatus as claimed in claim 1, wherein the C-Plane messaging to the O-RU comprises at least one of:
a Section Type 0 message with at least one of a Section Extension (SE) 7 message, an SE 10 message, an SE 11 message, an SE 16 message, and an SE 19 message; and
a Section Type 4 message with an SE 8 message.

4. The apparatus as claimed in claim 1, wherein:
the C-Plane messaging to the O-RU defines a selection of Transceiver (TRx) control parameters to reconfigure the antenna array to be applied to the O-RU; and
the C-Plane messaging to the O-RU comprises:
a Section Type 4 message comprising an ST4 command type header for activating or deactivating at least one TRx control parameter, and
a Section Type 0 message with at least one of an SE 10 message, an SE 11 message, an SE 16 message, and an SE 19 message.

5. The apparatus as claimed in claim 1, wherein:
the C-Plane messaging to the O-RU defines a selection of sleep mode parameters to reconfigure the O-RU; and
the C-Plane messaging to the O-RU comprises:
a Section Type 4 message comprising an ST4 command type header for activating or deactivating at least one sleep mode, and
a Section Type 0 message with at least one of an SE 10 message, an SE 11 message, an SE 16 message, and an SE 19 message.

6. The apparatus as claimed in claim 1, wherein the C-Plane messaging from the O-RU comprises at least one of:
a Section Type 4 Message including a parameter (ackNCKReqId); and
a Section Type 8 Message including a command field.

7. An apparatus comprising:
a radio unit (O-RU) configured to:
send, to a distributed unit (O-DU), configuration capability information of the O-RU via management plane (M-Plane) messaging;
receive, from the O-DU, an antenna array configuration supported by the O-RU via control plane (C-Plane) messaging or management plane (M-Plane) messaging, wherein the supported antenna array configuration is based on the configuration capability information of the O-RU and a request to reconfigure the antenna array from a higher-layer network function; and
based on the supported antenna array configuration for the O-RU, change the antenna array configuration of the O-RU.

8. The apparatus as claimed in claim 7, wherein the O-RU is further configured to:
send, to the O-DU, response to the change in the antenna array configuration via C-Plane messaging or M-Plane messaging.

9. The apparatus as claimed in claim 7, wherein the M-Plane messaging comprises at least one of a Yang model for capability reporting of TRx control parameters, a Yang model for capability reporting of sleep modes and associated parameters, and a Yang model for capability reporting of data layer control parameters.

10. A method comprising:
receiving, by a distributed unit (O-DU) from a radio unit (O-RU), configuration capability information via management plane (M-Plane) messaging from the O-RU;
receiving, by the O-DU from a higher-layer network function, a request to reconfigure an antenna array;
based on the configuration capability information from the O-RU and based on the request to reconfigure the antenna array from the higher-layer network function, determining, by the O-DU, an antenna array configuration supported by the O-RU; and
applying, by the O-DU, the supported antenna array configuration via C-Plane messaging or M-Plane messaging to the O-RU.

11. The method as claimed in claim 10, wherein the method is further comprises:
receiving, by the O-DU via C-Plane messaging or M-Plane messaging from the O-RU, a response to an antenna array configuration change to the supported antenna array configuration.

12. The method as claimed in claim 10, wherein the C-Plane messaging to the O-RU comprises at least one of:
a Section Type 0 message with at least one of a Section Extension (SE) 7 message, an SE 10 message, an SE 11 message, an SE 16 message, and an SE 19 message; and
a Section Type 4 message with an SE 8 message.

13. The method as claimed in claim 10, wherein:
the C-Plane messaging to the O-RU defines a selection of Transceiver (TRx) control parameters to reconfigure the antenna array to be applied to the O-RU; and
the C-Plane messaging to the O-RU comprises:
a Section Type 4 message comprising an ST4 command type header for activating or deactivating at least one TRx control parameter, and
a Section Type 0 message with at least one of an SE 10 message, an SE 11 message, an SE 16 message, and an SE 19 message.

14. The method as claimed in claim 10, wherein:
the C-Plane messaging to the O-RU defines a selection of sleep mode parameters to reconfigure the O-RU; and
the C-Plane messaging to the O-RU comprises:
a Section Type 4 message comprising an ST4 command type header for activating or deactivating at least one sleep mode, and
a Section Type 0 message with at least one of an SE 10 message, an SE 11 message, an SE 16 message, and an SE 19 message.

15. The method as claimed in claim 10, wherein the C-Plane messaging from the O-RU comprises at least one of:
a Section Type 4 Message including a parameter (ackNCKReqId); and
a Section Type 8 Message including a command field.

16. A method comprising:
sending, by a radio unit (O-RU) to a distributed unit (O-DU), configuration capability information via management plane (M-Plane) messaging;
receiving, by the O-RU from the O-DU, an antenna array configuration supported by the O-RU via control plane (C-Plane) messaging or management plane (M-Plane) messaging, wherein the supported antenna array configuration is based on the configuration capability information of the O-RU and a request to reconfigure the antenna array from a higher-layer network function; and
based on the supported antenna array configuration for the O-RU, changing, by the O-RU, the antenna array configuration of the O-RU.

17. The method as claimed in claim 16, wherein the method further comprising:
sending, by the O-RU to the O-DU, a response to an antenna array configuration change to the supported antenna array configuration via C-Plane messaging or M-Plane messaging.

18. The method as claimed in claim 16, wherein the M-Plane messaging comprises at least one of a Yang model for capability reporting of TRx control parameters, a Yang model for capability reporting of sleep modes and associated parameters, and a Yang model for capability reporting of data layer control parameters.
